(19) United States
(12) Patent Application Publication
(10) Pub. No.: US 2020/0034040 A1
(43) Pub. Date: Jan. 30, 2020

(54) Data Architecture Based on Sub-allocation and References from Fragmented Data Blocks

(71) Applicant: Sid GARMAN, North Waltham, MA (US)

(72) Inventor: Sid GARMAN, North Waltham, MA (US)

(21) Appl. No.: 16/376,489

(22) Filed: Apr. 5, 2019

Related U.S. Application Data
(60) Provisional application No. 62/702,722, filed on Jul. 24, 2018.

(51) Int. Cl. G06F 3/06

(52) U.S. Cl. CPC G06F 3/064; G06F 3/0608; G06F 3/0685; G06F 3/0653; G06F 3/0611

(57) ABSTRACT

A data architecture comprising a software program at the firmware level or hiring that monitors system activity in order to intelligently reallocate data blocks based on the optimization of data according to a highly local reference. In monitoring system activity, the program is able to optimize both storage space required and access speed depending on the context in which the data is utilized.

### FIELD OF INVENTION

This invention generally relates to file systems and, more specifically, to the data architecture of fragmented file systems.

### BACKGROUND OF INVENTION

In computing a file system refers to a general class of software that organizes a physical storage medium making it capable of holding data in a logical manner so that an operating system can access the data stored. The file systems store the data in what are called data blocks which are composed of many bits of smaller information. Data blocks are generally arranged in some logical order of data that relates to each other whether this is the necessary data for an application, or a text file, or any other form of data, this is shown in FIG. 1A.

Many current file systems arrange data in the largest blocks possible as this has been the most efficient method for previously known types of storage technology, as shown in FIG. 17. However, there are two unintended consequences from using this methodology. One, due to the nature of file system blocks, data may not precisely fit within the block space. The system would then need to fill the rest of the block with slack space as seen in FIG. 2. What this results in is extra space taken up by smaller pieces of data resulting in wasted space. This is in contrast to the increased speed reading from and writing to modern storage media for smaller pieces of data in comparison to larger pieces of data in.

The second issue relates to the access speed for current storage technology. While large blocks of consistent types of data are able to achieve relatively high I/O (input/output) speeds for reading from and writing to current storage technology, diverse types of data within a larger data block can cause the I/O speeds to drastically slow. Both of these issues exacerbate the issue of file system fragmentation.

File system fragmentation refers to smaller pieces of data being placed non-contiguously in a data block. What this results in is increased slack space, and increased access times. The reason for this fragmentation is that it is much easier for the file system to store modifications to data in a fragmented area, whereas it is much faster to access data when the data is contiguous. Fragmentation is especially an issue when there are diverse data types involved as each is accessed in different manners. Therefore, when a larger data block has many different data types it will move at the speed of the slowest data type.

Currently there exists a broader methodology within several file systems that helps to resolve the issue of the amount of slack space that is generated by small files. This methodology is called sub-allocation, which effectively opens up the slack space to be used by other data small enough to fit in that space. Not only does this technique reduce overall disc space used, but it increases the access speed of the data at the same time.

In addition to the above file system concepts, the concept of memory paging is also important. Paging refers to the practice of sending needed data from the slower non-volatile hard drives to the faster volatile RAM. Volatility in this context means that there needs to be power in order for that data to remain stored. Effectively, paging allows data to be accessed more quickly, but with the downside of the data stored in the RAM no longer being stored once power is removed from the system.

### SUMMARY OF INVENTION

The previously described drawbacks of the background art are overcome by providing a system and method for more efficient data storage in a non-volatile medium, by increasing the locality of reference for any given data block. Preferably, the system and method also feature a sub-allocation function to increase storage efficiency. According to at least some embodiments, the system and method further feature a volatile memory for temporarily storing information regarding a location of one or more data blocks in the non-volatile medium.

Preferably, the system and method break a larger block of data into smaller blocks of consistent data and then reconstruct the smaller blocks into larger blocks, if necessary, with high locality of reference. The larger block of data is preferably broken into smaller blocks according to the I/O, or read/write, needs of the system; that is, how the system is using the data. The system and method preferably use a bit array to tag data or issue a reference to the data in the paging system of the volatile memory.

The present invention, in at least some embodiments, relates to a data architecture that would assist already existing file systems or would comprise an entirely new file system. This data architecture would allow for existing file systems to improve access speeds to data stored within them. Preferably, the data architecture is accompanied by a sub-allocation method in order to benefit from storage efficiencies. The combination of this data architecture and an additional optional sub-allocation method would provide an access speed advantage, and potential storage size efficiencies.

Without wishing to be limited by a single hypothesis, the scale of the storage efficiencies from the sub-allocation of highly local data depends on how much extra space the data architecture would take up in assigning bit arrays in defining the location of the data. At the same time, if volatile memory is used to store the reference of the data's location, there would be no additional non-volatile storage space used in the process. Using volatile memory to store the reference of the location of the data would result in an increased number of page files existing on the volatile memory. However, such page files would merely include references to the data's location on the non-volatile storage space and would not store the data itself on the volatile memory. While decreasing the amount of volatile storage needed, it would not allow direct editing of the referenced data until the data is fetched from the hard drive. Depending on whether data modification, or data access is the priority the system can adapt to optimize I/O speeds in different contexts.

As previously described, the present invention features a method of optimization of data blocks based around increasing the locality of reference for any given data block. According to at least some embodiments, the method comprises at least one of sub-allocating data into more localized data blocks; and issuing more localized references to this data. The method of sub-allocating data into more localized data blocks is preferably performed with regard to the non-volatile storage as it increases the access speed of the data, especially when diverse data types are stored together.

The method of issuing more localized references is preferably performed for paging on a volatile storage medium when direct access to the data is not needed. The second method particularly concerns querying of data, as diverse data types drastically increase the amount of time it takes to query data blocks. Utilizing this invention's methodology, the time it takes to query diverse data types is vastly decreased as the locality of reference is increased at the non-volatile level and at the volatile level there is a higher locality to the references that are given to the paging without needing to store the entire data block.

The system and method accomplish the aforementioned optimization by monitoring how and when a system accesses data. By monitoring the access of data, the invention is able to intelligently reconstruct the hierarchy of data in a way that would be more efficient for the system depending on the context. In the case of queried data, the invention would notice what data is being accessed from which queries and sub-allocate that data to its own data block with a new more local reference, so that non-relevant queries do not have to process the irrelevant data. The method would have a further advantage in that it would be able to further sub-allocate an already more local data block into blocks dependent on data type. This would allow the file system to tail pack similar types of data into consistent blocks of similar types of data. Preferably, the system and method break a larger block into smaller blocks of consistent data and would then reconstruct the smaller blocks into larger blocks, if necessary, with high locality of reference. The system and method preferably use a bit array to tag data or issue a reference to the data in the paging system. Without wishing to be limited by a closed list, one advantage is that the invention intelligently reconstructs the data in a file system to be most effective and efficient depending on the context the file system operates. This allows the file system to optimize both access speed and storage.

Additionally, given that the system and method are able to intelligently organize data in such a manner that is more efficient for the file system, the system and method are also capable of organizing the data based on the memory hierarchy that it detects. Effectively, based on the monitoring of the data, the system and method are would be able to determine what storage medium would be the most effective location for a given piece of data or data block. Preferably, immediately needed small pieces of data would be passed to more rapidly accessible storage, such as processor level caches for example. Conversely, the system and method are would be able to detect if there are infrequently accessed data blocks and would automatically allocate them to “colder” storage, or storage that is slower, but in practice also less expensive. Optionally the system and method feature identifying storage media that are slower and larger to place infrequently accessed data, and preferably the system and method relate to placing low value data in low cost storage.

The present invention involves, in at least some embodiments, performing sub allocation in such a manner that the increased access speed is provided, due to the fact that the sub allocated blocks allow a much stronger locality of reference. A standard definition for locality of reference is the tendency for a processor to access the same set of memory locations over time. In this context a stronger locality of reference would mean using a machine learning algorithm that would predict what memory locations that the processor would access with a high degree of accuracy. By utilizing a machine learning algorithm, the accuracy can improve over time and also handle any potential changes in the pattern of how a processor accesses memory. Having an algorithm that is able to accurately predict the next location the processor will access will mean that the amount of time to access necessary resources is substantially decreased.

US Patent Application No. 2004/0184340 relates to a hardware system for incorporating different types of memory within a single memory device, including for example slower, lower cost memory and faster, more expensive memory. A particular method for memory interleaving is disclosed. However, this application relies upon a dedicated memory that has a particular construction.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computing device”, a “computer”, or “mobile device”, it should be noted that optionally any device featuring a data processor and the ability to execute one or more instructions may be described as a computer, including but not limited to any type of personal computer (PC), a server, a distributed server, a virtual server, a cloud computing platform, a cellular telephone, an IP telephone, a smartphone, or a PDA (personal digital assistant). Any two or more of such devices in communication with each other may optionally comprise a “network” or a “computer network”.

### BRIEF DESCRIPTION OF DRAWINGS

The invention could be better understood by referring to the following description of the accompanying figures:

FIG. 1 is a block diagram illustrating the organization of a conventional data block;

FIG. 2 is a block diagram illustrating how slack space and fragmentation is created in modern file systems;

FIG. 3 is a flow chart depicting the series of steps the invention takes in determining how to sub-allocate a data block based on temporal inefficiencies;

FIG. 4 is a flow chart depicting the process of sending a highly local reference to the volatile memory;

FIG. 5 is a block diagram depicting tail packing data blocks with consistent types of data;

FIG. 6 is a flow chart illustrating the process of reconstructing larger data blocks based on smaller data blocks of a defined data type;

FIG. 7 is a flow chart outlining the process for optimizing the data structure based on monitoring how the file system is used;

FIG. 8 is a flow chart depicting the process of determining the most efficient storage hierarchy;

FIG. 9 is a flow chart illustrating the process of optimizing the data architecture based on cost;

FIG. 10 is a block diagram showcasing breaking down a larger inconsistent data block, into more consistent and highly local data blocks;

FIG. 11 is a block diagram detailing how several data blocks would be optimized for optimal access speed;

FIG. 12 is a block diagram depicting how several data blocks would be optimized for storage space;

FIGS. 13A and 13B show non-limiting, exemplary systems for supporting efficient data storage according to at least some embodiments of the present invention;

FIG. 14 is an illustration depicting a generic program application user interface that would utilize at least some of the embodiments of the present invention;

FIG. 15 is a flowchart depicting a non-limiting exemplary process for determining the formats of files at a bit level;

FIG. 16 is a flowchart illustrating a non-limiting exemplary process for correcting for file format errors or inefficiencies;

FIG. 17 is a block diagram showcasing an example of how a smaller piece of data is added to an existing data block;

FIG. 18 showcases an exemplary system existing in an online cloud-based architecture that utilizes at least some of the embodiments of the present invention;

FIG. 19 is a flow chart that details an exemplary error prevention method in regard to use of system resources;

FIG. 20 is a block diagram illustrating the basic structure of objects in an object storage system; and

FIG. 21 illustrates the difference between how blocks are stored in a block storage device and how objects are stored in an object storage device.

### DETAILED DESCRIPTION OF ILLUSTRATIVE EMBODIMENT

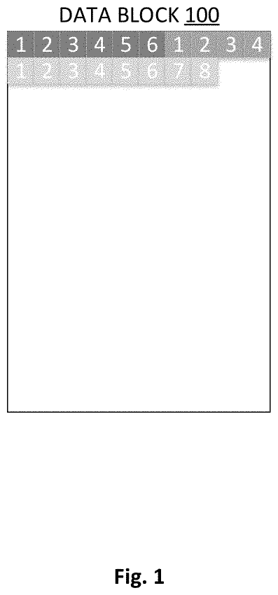

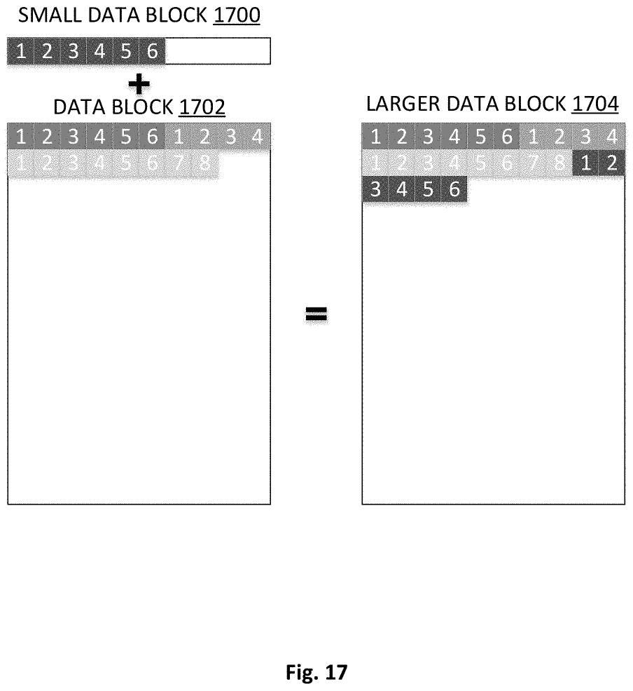

FIGS. 1, 2 and 17 illustrate the deficiencies with currently available data storage systems. FIG. 1 is a block diagram of a standard data block 100. Within it are smaller bits of data that make up a larger piece of information such as a file. These smaller bits of data, or data blocks, can be combined for more efficient storage. FIG. 17 expands on FIG. 1 by showing a non-limiting example of how a file system normally adds smaller data blocks 1700 into larger ones 1702 to form an even larger combined data block 1704. The smaller data blocks in this instance do not mean that the file system conventionally uses different sized data blocks. Instead, smaller data blocks refer to an array of data that has been recently created. The file system will then store that array where convenient. One possibility is the smaller data block being entered into a brand new empty data block. While this could be the simplest solution for the file system, this would create many inefficiencies, especially in regard to storage space, and the locality of reference. Issues regarding the locality of references can further be delineated between issues when the data belongs to a larger set, and issues with access speed in a larger data collection.

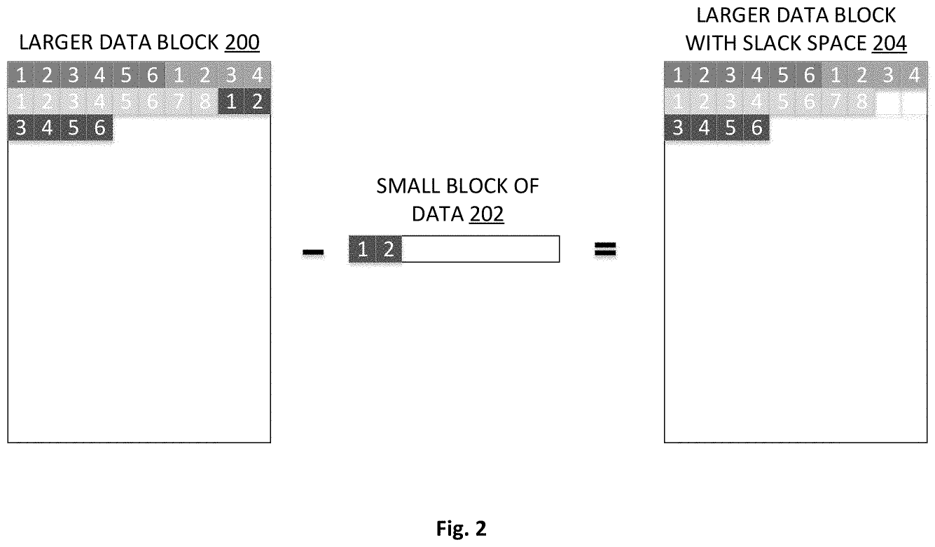

FIG. 2 is a block diagram based on the final data block 1706 from FIG. 17. FIG. 2 shows the process of how a data block once filled becomes fragmented in many file systems 204. This process also illustrates how slack space is created. To explain the process, a small block of data 202 is deleted within the original data block 200, this results in empty memory spaces in the data block 204. This leads to incongruent data within the data block, and additional space utilized when unnecessary. FIGS. 1, 2, and 17 relate to examples of how many file systems operate. It will be apparent to those skilled in the art that the techniques herein may be applied to other file systems that do not have the issues in FIGS. 1, 2, and 17.

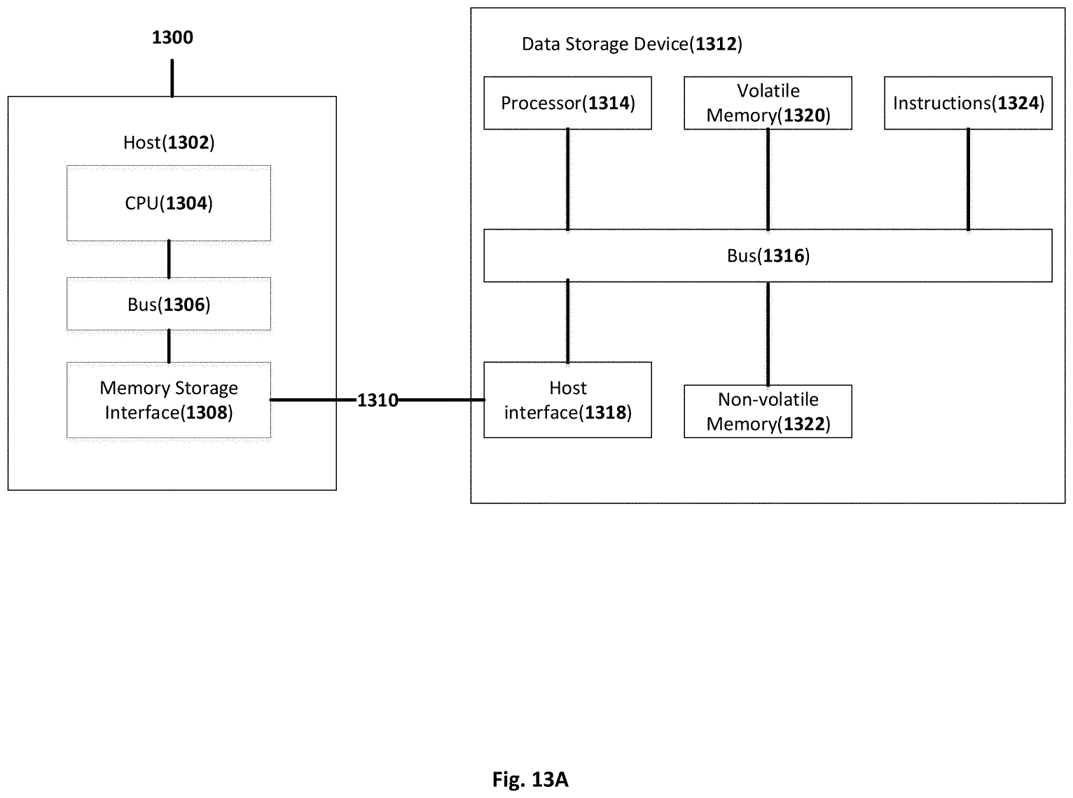

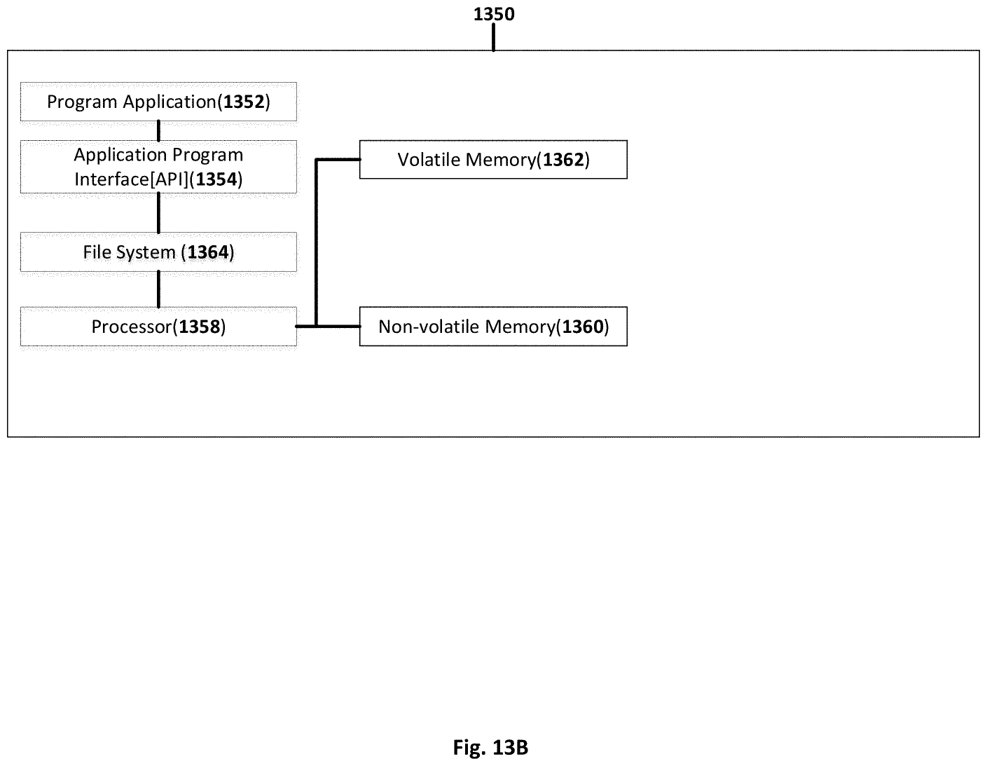

As previously described, the present invention, in at least some embodiments, overcomes the issues shown in FIGS. 1 and 2 by storing data more efficiently. Some embodiments of an exemplary system for supporting the methods described herein are now provided. FIGS. 13A and 13B show non-limiting, exemplary systems for supporting efficient data storage according to at least some embodiments of the present invention. FIG. 13A relates to a non-limiting example of a system that is operative for data storage transactions at the level of firmware while FIG. 13B relates to a non-limiting example of a system that is operative for data storage transactions at the level of a program application.

Without wishing to be limited in any way, both systems may be used for implementation of the methods described herein. However, the more access controls, and the more layers the program has to go through in order to operate, the lower the operating efficiency due to a bottleneck. This bottleneck can either exist in lower effectiveness, or efficiency, depending on the layer at which the system is operative.

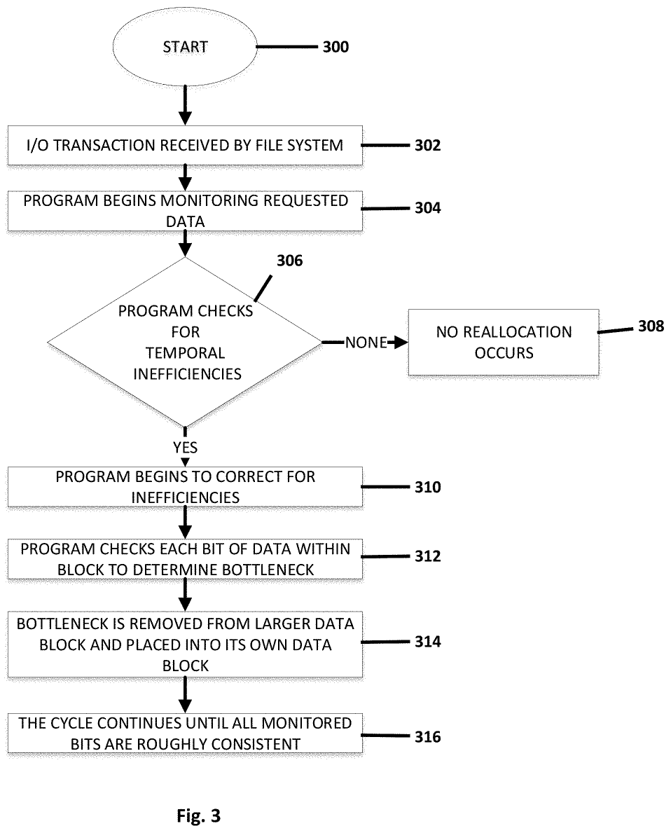

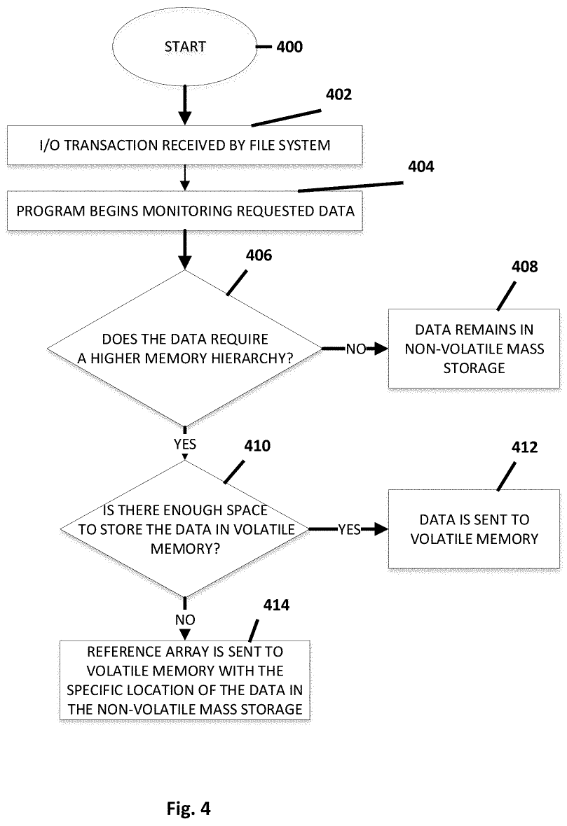

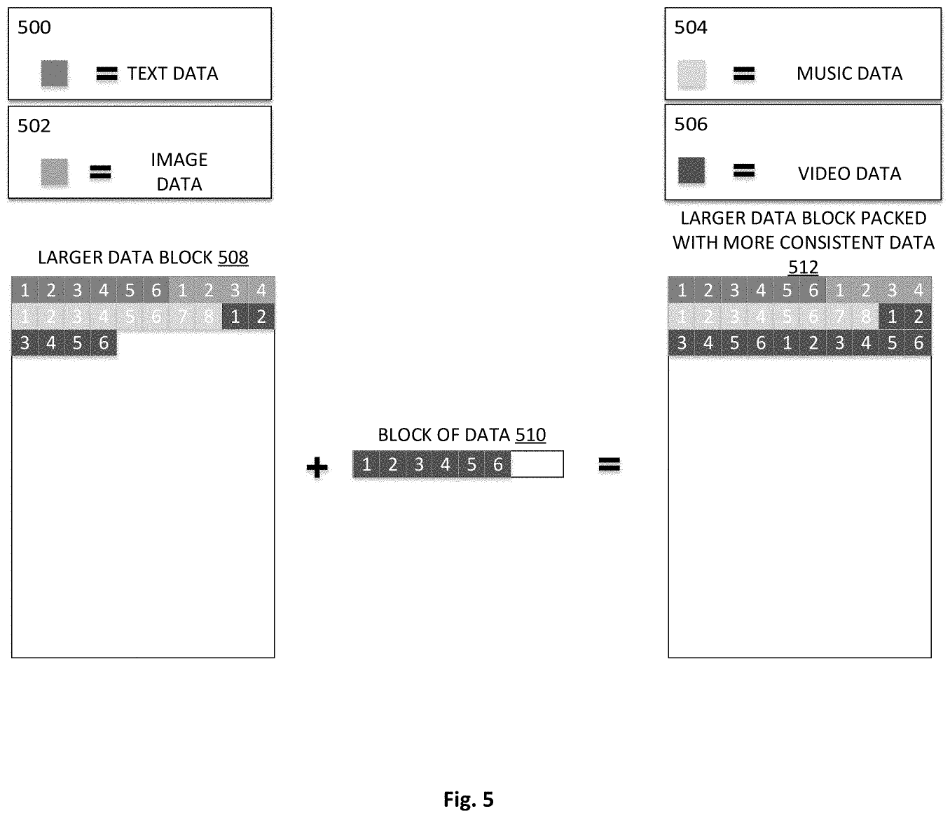

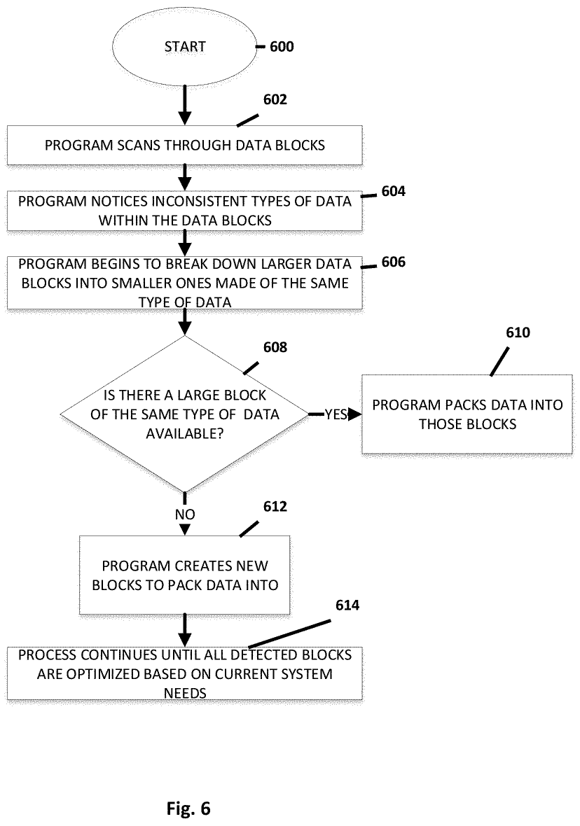

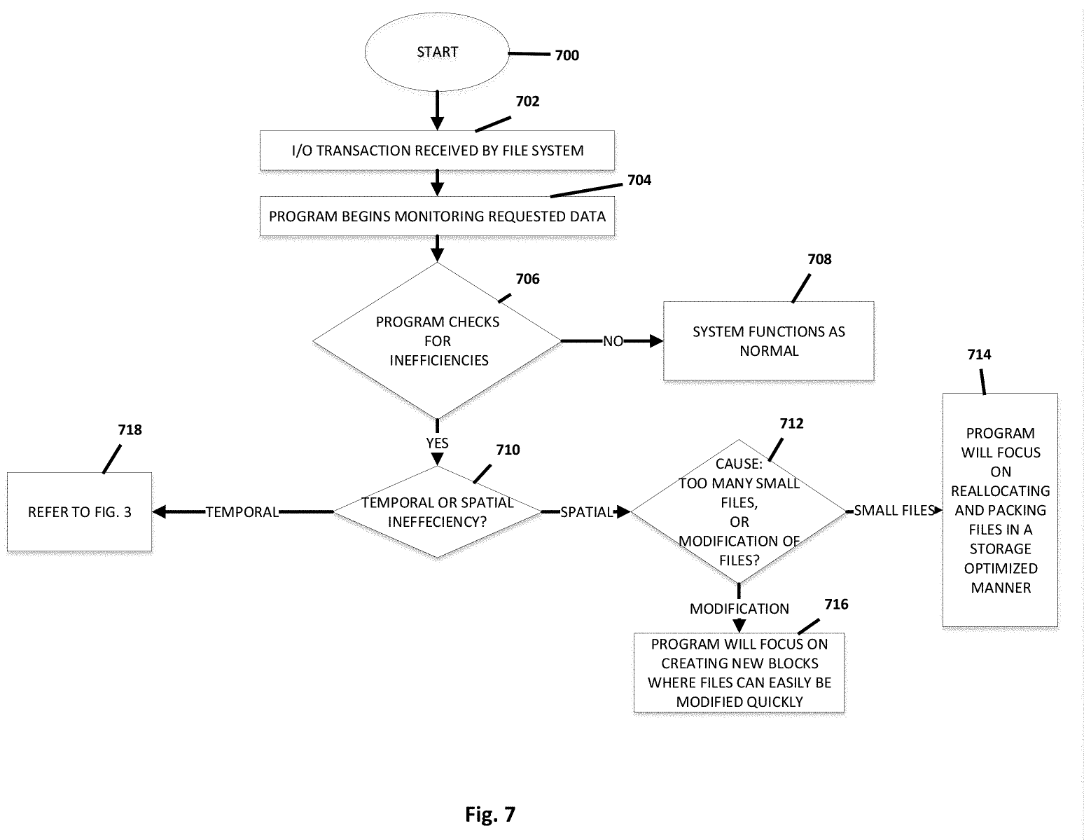

For either of FIGS. 13A or 13B, the program implementing the method on the system hardware as described herein may perform a variety of actions to increase the efficacy of data storage. For example, as described with regard to FIG. 3, the program may check for temporal inefficiencies in storage, which may cause delays in data retrieval. If such temporal inefficiencies are located, then the program may cause data to be redistributed in the system hardware storage in order to increase efficiency of retrieval. For data that is considered to be of lower value for rapid retrieval, whether determined by the user or by the program, the data may be stored in a lower cost storage. This lower cost storage may itself be less efficient for data retrieval. However, even in this case, it is possible to increase the temporal efficiency of storage through data reallocation.

FIG. 4 describes a non-limiting method for redistributing data across different types of data storage, in order to increase the efficiency of retrieval for certain data or to reduce cost of storage. FIGS. 5 and 6 relate to a method to increase the efficiency of retrieval by packing similar types of data together in data storage blocks. Other methods are also described herein, which may be used with the system of FIGS. 13A and 13B.

Turning now to FIG. 13A, a system 1300 features a host 1302 for reading data from and writing data to a data storage device 1312. Host 1302 may be implemented in an integrated circuit (IC), a mother board, or a system on chip (SoC), but the application is not restricted to these examples.

Data storage device 1312 as shown herein is a non-limiting example; many other configurations for such a device are known in the art and could be implemented with the present invention as described herein. Data storage device 1312 may be implemented as a flash-based memory device, but the application is not restricted to this example. Data storage device 1312 may be implemented as a solid-state drive or solid-state disk (SSD), a universal flash storage (UFS), a multimedia card (MMC), or an embedded MMC (eMMC). Alternatively, Data storage device 1312 may be implemented as a hard disk drive (HDD). Data storage device 1312 may be attached to or detached from the host 1302. Host 1302 communicates with data storage device 1312 through an interface 1310.

Host 1302 features a CPU 1304 in communication with a bus 1306. Bus 1306 may be an advanced microcontroller bus architecture (AMBA), advanced extensible interface (AXI), advanced peripheral bus (APB), or advanced high-performance bus (AHB), but the application is not restricted to these examples. Bus 1306 is also in communication with a memory storage interface 1308, which supports communication with a host interface 1318 on data storage device 1312. Host 1302 sends I/O commands to data storage device 1312 through memory storage interface 1308, to interface 1310; such commands are then received by data storage device 1312 through host interface 1318. Collectively interface 1310, memory storage interface 1308 and host interface 1318 may support a peripheral component interconnect express (PCIe) protocol, a serial advanced technology attachment (SATA) protocol, a SATA express (SATAe) protocol, a SAS (serial attached small computer system interface (SCSI)) protocol, or a non-volatile memory express (NVMe) protocol, but the application is not restricted to these examples.

Execution of the commands of host 1302 is controlled by a processor 1314 at data storage device 1312. As used herein, a processor generally refers to a device or combination of devices having circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Processor 1314 communicates with a bus 1316, which may be implemented according to any suitable architecture, such as the previously described bus architecture. Bus 1316 also communicates with the previously described host interface 1318. Bus 1316 also communicates with a volatile memory 1320, a non-volatile memory 1322 and an instructions module 1324. Instructions module 1324 is preferably implemented at the level of firmware.

The below described methods may optionally be performed on system 1300 according to the plurality of instructions stored in instructions module 1324. Alternatively, such instructions may be stored at host 1302 (not shown). In any case, the plurality of instructions preferably includes instructions for dividing data for transactions, such as read/write transactions, into a plurality of smaller blocks. These smaller blocks are then preferably arranged according to data type, such that similar data types are stored together, for more efficient read/write transactions. The blocks of data are preferably stored in non-volatile memory 1322. Optionally, pointers to the location of such blocks of data are stored in volatile memory 1324, such that instructions for read/write transactions may be more rapidly performed by processor 1314.

Optionally, data storage device 1312 features a plurality of different types of non-volatile memory (not shown), such that processor 1314 may determine which type of non-volatile memory is to be used for storing a particular type of data. For example, slower but presumably cheaper memory could be used to store data that is required infrequently, while faster but presumably more expensive memory could be used to store data that is required more frequently.

System 1300 may optionally be implemented as any computational device, including but not limited to a mobile device, a cellular telephone, a smart phone, a desktop computer, a laptop computer, a cloud computing system and the like.

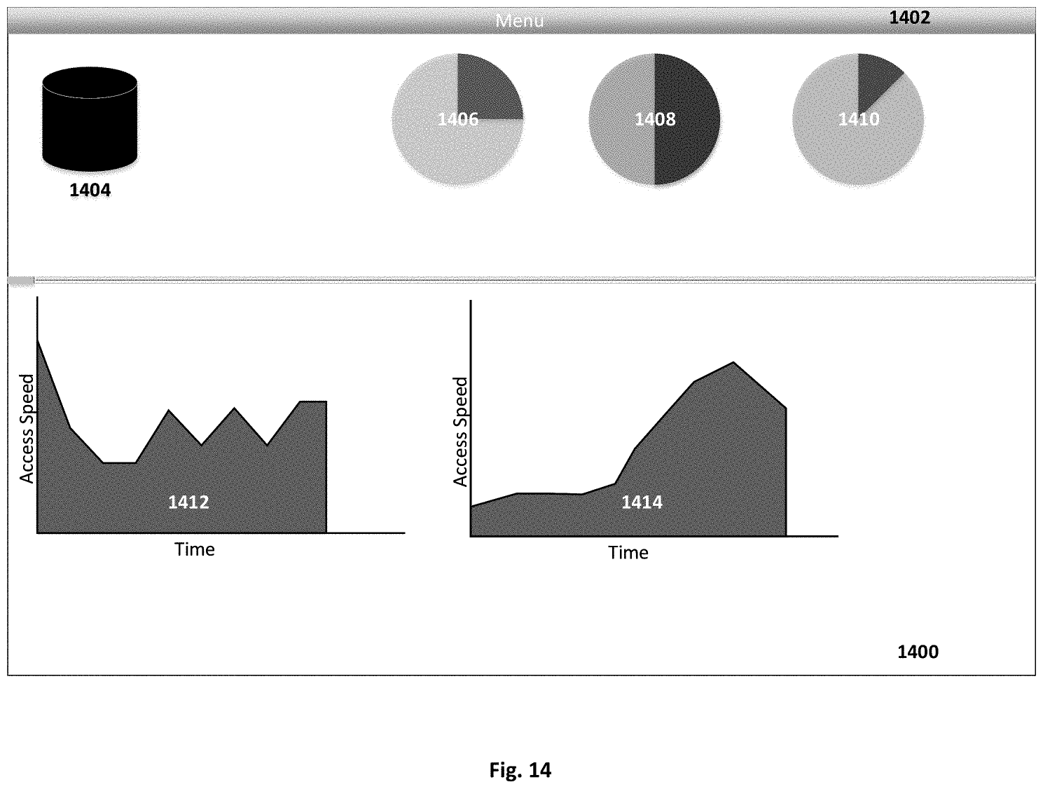

FIG. 13B shows a non-limiting exemplary system which supports performance of the below methods at the program application level. As shown, a computational device 1350 features a program application 1352, which determines how data is stored on a non-volatile memory 1360 and a volatile memory 1362. Program application 1352 sends instructions to be executed by a processor 1356 through an application programming interface 1354. The program application 1352 will monitor system resources, for example optionally in a manner illustrated in FIG. 14. When the program application 1352 detects that there are misallocated resources it will attempt to correct the problem depending on the level of access the program application 1352 has for the hardware, and specifically for the associated memory and storage.

Regardless of the level of access the program application 1352 has, the program application 1352 will issue commands through an API 1354 to tell the processor 1358 what is the optimal allocation for the data that is misallocated, according to the access to memory and storage by program application 1352. The API 1354 can be used in a standalone program application, for example an application similar to the one depicted in FIG. 14; or, the API 1354 can exist within a larger program application serving the same functionality but having a different user experience. For example, instead of an application dedicated to the efficient reallocation of data blocks, the methodology can exist within an application dedicated to monitoring a storage device. The exemplary program application shown in FIG. 14 represents one possibility for data visualization of what underlying interactions and operations are occurring. However, the API 1354 is preferably the element that issues commands to the processor based on the demands of the application it is tied into.

API 1354 is preferably able to monitor a file system 1364 and the storage system (non-volatile memory 1360 and volatile memory 1362 of the computational device 1350. Alternatively or additionally, program application 1352 is able to perform such monitoring through API 1354. Preferably, monitoring input/output operations of the storage system includes monitoring temporal and spatial data access. Data access includes data being read from and written to the storage system. Program application 1352 and API 1354 are therefore preferably able to monitor such data access.

In addition, program application 1352 preferably accesses the file system 1364 through API 1354, to analyze a connection between storage system input/output operations and file operations. File system operations involves a series of operations that are abstracted from the block level storage. A key feature of this invention is the monitoring of abstracted processes to intelligently correlate abstract activities with activities on the physical hardware. The reasoning is that in the process of abstraction latency is introduced to the system. By intelligently correlating file system activity with storage activity a map can be constructed of all data on a device. This map can then be utilized to optimize the processing of said data when said data is required to be used.

Program application 1352 then analyzes data blocks to determine how those data blocks are correlated with file system files and metadata about said data blocks. Program application 1352 then constructs a map of data blocks according to the metadata to correlate the data blocks with data composing said blocks. The process the program application 1352 will take to construct the map of data blocks involves monitoring system activity encompassing file system activity, hardware activity including storage, and network activity. By monitoring complete system activity, the program application 1352 can begin to piece together a digital map of how each bit of data is utilized by any given process. Further system monitoring can pick up more information such as access speed of any given bit by monitoring how that data is accessed over a period of time. This will allow the program application to construct another map of file type by monitoring data that has similar access speeds. Furthermore, the process can be further refined to identify encoding standards by monitoring data that has access speeds within certain statistical bands of the access speeds of the general file type.

Due to the file system being abstracted from the physical hardware the hardware itself cannot optimize itself based on file system inefficiencies. This is because the file system is encoded in such a manner that is unintelligible to the physical hardware. However, a program application such as 1352 can rectify this issue by monitoring the total system activity and communicating via an API 1354 in such a manner to tell the processor how to optimize the storage system. The program application can do this because it can understand the file system and the storage system. However, a program application needs the methodologies present in this invention in order to be able to correlate the activity of the storage system and the file system. This is also true for object-based storage systems. The program application can make a map or matrix of storage locations compared to file or object locations by utilizing the basic methods outlined above. But specifically, the program application is observing file and object activity happening across time and specific locality and relating that to storage system activity and specific locality. The amount of time the program application needs to construct the map depends on the level of randomness of data of any given data block.

After the program application 1352 has constructed some basic maps regarding the file or object system and the storage system the program application will have sufficient data to begin testing the system 1350 for data operation inefficiencies. Due to possible inefficiencies in regard to external media it is possible that the program application does not have native input/output per second capabilities of the data. For example, as the program application collects meta data from the data of the system it is entirely possible it could include data from a USB2.0 transfer which may not be reflective of the potential of that dataset. Due to the potential for inaccurate data being logged by the program application, it is necessary to conduct a performance evaluation of the data in regard to its input/output per second capability. The actual performance test is simple, and the amount of time is highly dependent on the size of the cache of the processor. The reason for this is due to the test utilizing the processor cache to conduct the performance test due to the fact that the cache is the fastest available memory available. In particular the size of the L1 and L2 cache is of the most importance. While the L1 cache is the fastest, the performance between L1 and L2 is in general negligible for the test, in certain circumstances only the L1 cache may be used, but this would also be user configurable. However, L3 cache is substantially slower in comparison and would not be used during the test.

The structure of the test would be to use the L1 and L2 cache to access and transfer every bit of data for which the program application has access. The amount of time for the process to take place is dependent on the amount of data to be evaluated. Also, it is not suitable for the entire L1 cache to be used due to vital system resources that would need access to the L1 cache. At the same time, due to the high speed of the L1 and L2 cache the test will be fairly rapid even for large amounts of data. This is in comparison to standard search operations that many organizations and individuals conduct using non-volatile memory which is several orders of magnitude slower than the L1 and L2 cache. After the performance evaluation has concluded the program application will not only have a map of bits and their relation to file system locations, but also a map of the access speed of each of these bits. These maps can be compared to the meta-data of certain types of storage systems. However, the maps are much more complete as they not only will have information about what data is stored, but where that data is stored on the physical device, and the speed at which that data can be accessed.

With a map of the true access speeds of each bit of data the program application can begin to check for inefficiencies in the data block. The process to check for inefficiencies involves using the map for access speeds, and the map of bits inside data blocks. The maps involving file systems or object systems are not necessary for inefficiency testing, they are necessary for checking for errors. The program application will use the map of data blocks and their underlying bit makeup and will then conduct an analysis on the average speed of the the data block. The program application can also test the access speed by conducting a performance test that is similar to the bit performance test. However, it is not necessary to conduct the performance test as the block will always perform worse than any given bit of data. To conduct a performance test while it would ensure accuracy of the increased performance, would also waste system resources on evaluating the data blocks when those resources could be better spent fixing any inefficiencies. The program application can also utilize the map of access speeds to get an accurate idea of the access speed which the entire block will transfer. This is due to the fact that an entire data block will transfer at the speed of the slowest bit of data within that data block. The reason for this is due to the fact that a data block must be access in its entirety on the hardware level. The amount of data that needs to be accessed depends on software settings either in the file system or block storage specific software such as firmware that alters the size of data blocks that are stored. While object-based systems that do not utilize block storage hardware do not have any issues regarding block storage inefficiencies they can have block storage issues when transferring to external systems that are based on block storage. Regardless, the difference between the fastest bit of data in a data block and the slowest bit of data in a data block is the theoretical inefficiency of the data block. As said before a performance test can be run to test the experimental inefficiency of the data block, but it should be noted that experimental values can differ for many reasons from the theoretical value. Additionally, it should be noted that the inefficiency should be regarded as a relative value as the transfer across different storage mediums can result in different speeds. Therefore, it is important to account for the different access speed potentials of any storage device and compare the access speed differential natively to that medium. This is why the program application utilizes the map that it created of the data bit access speed and the data block map to find inefficiencies. An inefficiency cannot be immediately found when comparing access speed across different media, it is important to calculate what is the theoretical highest potential for the access speed of any given bit of data before drawing a conclusion regarding the inefficiency of the data operation.

The above process in finding data operation inefficiencies focuses on the program application actively searching out inefficiencies. The program application can also use the process selectively by monitoring system activity and only identifying data operation inefficiencies based on data that is currently being utilized. While the active process can help in the long term and with overall operations, the active process will require dedicated resources in order to conduct the evaluations necessary to optimize any inefficiencies. At the same time the active process itself should be viewed in a similar lens to disc defragmentation or anti-virus scanning. In fact, it is the optimization stage that is more intense on the hardware due to the calculations that need to take place.

The gathering of additional data before beginning any process that conducts changes is important not just for optimizing data operations, but also for determining whether the process should begin in the first place. It is necessary to conduct a pre-optimization evaluation due to the fact that certain inefficiencies take place on a time scale too small for a system to benefit from any optimization. This is particularly true for data that is rarely accessed. At the same time, optimization of rarely accessed data could have long term benefits due to the fact that the data would already be optimized when the data is accessed at any point in the future. Just as there is a proactive scan mode for inefficiencies there can be a proactive optimization mode for inefficiencies. This would mean that the program application during a dedicated period of time would actively fix any existing inefficiencies. In comparison, during a passive monitoring process the program application would need to determine whether the optimization operation would be successful as the optimization process would require allocating system resources to the optimization process.

The system resource check and the operation success check are intertwined due to the fact that without both the operation cannot take place. In order to determine whether or not the operation will be successful the program application will monitor system activity for repeated activity or activity that exists on time scales greater than the access speed of the L2 cache. The reason for tying the time scale to the L2 cache is due to the same reason the L2 cache is utilized in the access speed performance test. In other words, beyond the L2 cache access speed becomes prohibitively slower and in essence any data being access is being access inefficiently compared to its true potential. This is not to say that all data must be access by the L2 or L1 cache in order to be efficient as that would be prohibitive. The point is that beyond the L2 cache data operations take place on a time scale that makes any optimization carry huge benefits. On the other hand, operations that take place in the L2 or L1 cache can be inefficient because these operations exist on time scales so small that any optimization would have less absolute benefit. However, when it comes to high performance operations the relative benefit takes place across all memory media regardless of access speed. What this means is that for high performance computing the relative benefit of optimization can carry huge positive results over the long term, regardless of little short-term absolute benefit in the realm of how many seconds are saved per operation.

Therefore, in order to determine whether an optimization operation would be successful the program application will first check whether the activity is taking place in a storage location slower than the L2 cache. Secondly, the program application will monitor the data blocks being accessed and determine the differential between the bits with the highest access speed and the slowest access speed within the same block. Third, the program application will calculate the amount of time saved by the increase in access speed for the monitored blocks. The reason the third step is necessary is due to the fact that the user could set a percentile threshold for which the program application would conduct an optimization operation. This will not only focus the program application to certain extremely inefficient blocks but would also decrease the amount of system resources that needed to be utilized over time. Additionally, the third step is essentially a check to see if the optimization would truly increase performance of the system. While any optimization would increase performance, the percentile-based method allows a user to select tradeoffs between raw absolute performance or system utilization over performance. What system utilization over performance means is that the system has to keep running and continuing its current activity no matter what, so while optimizing the activity will have benefits in the long run, there cannot be any short-term sacrifices in order to optimize. It is important that a user is able to make the judgement for themselves what a performance evaluation will entail as the determination for when to optimize is key for the optimization to take place. Optimization requires system resources, and if those system resources cannot be spared then system stability is preferable to system performance.

The final step before the system resource check is to undergo an error prevention process. The program application utilizing the maps it has created will determine whether or not there are data blocks being accessed by the L2 or L1 cache that require the data blocks that are marked for optimization. If there are data blocks in the L2 or L1 cache that require the marked data blocks, the program application will not carry out the process due to a check against corruption of the process that is utilizing that data set. The reason for this check is that the optimization process itself for any given block is quick due to utilizing high access speed memory. However, the process itself is not fast enough to counter act a reference error that would develop when data in the L1 or L2 cache wants to refer to data in lower access speed memory. The data block marked for optimization will still be marked and can be optimized once it is not being referred to by other data or being accessed itself. However, if the data block is being access itself in the L3 cache or memory of slower speed, the data block can be optimized while being accessed due to the speed at which the new references can be put in place before the next operation takes place is at least an order of a magnitude faster than the L3 cache or memory of slower speed can access the data block.

After all the above checks have taken place there is one final check that takes place for optimization can take place. The program application will check to see if the system has the available resources necessary to conduct the optimization. While in previous examples the L2 and L1 cache were necessary in order to unlock the performance of a given bit of data the L1 and L2 cache are not necessary in order to optimize the data block. However, the L1 and L2 cache are necessary to optimize data blocks that are currently being accessed by L3 cache and slower memory. But, as stated in the error prevention mechanism if there is data in the L1 and L2 cache that is referring to data in the L3 cache or slower memory, than no memory would be fast enough to optimize the memory in the L3 cache or lower. If the data blocks that are marked for optimization are not currently being accessed than any memory that is attached to the processor will suffice for the optimization process. The only other resource necessary for optimization is that the processor is not fully utilized during the optimization process. The processor needs to be capable of receiving and issuing instructions in order for optimization to occur. After all the checks have taken place the optimization process can begin.

Stating all of this the overall process for optimization involves loading the data block marked for optimization into some memory connected to the processor. The program application 1352 will then issue instructions to optimize the data block via the API 1354 to send to the processor 1358. These instructions in general will include moving data from a data block into a new or existing data block, the creation of new data blocks, creating references to data in data blocks, and other memory operations necessary to carry out the changes on physical hardware and creating references to new locations. All these operations take place on the physical hardware, operations on abstracted software such as object and file storage systems involve changing the references to the location of the data in the file system as it relates to the data on the physical device. This is why it is necessary to have many maps that relate hardware to software, and the access speed of the data. While all the above procedures relate to the actual process of optimization it does not cover the methodology utilized in creating the goal data block. The goal is to create a data block that has an access speed as close to possible as to the fastest bit of data within the data block. Ideally, the data block access speed would have a 1:1 ratio compared to the highest access speed bit of data within that data block. However, the user can make the determination of which ratio is best for them in accordance with the performance check outlined above. While object-based storage can have hardware that does not utilize data blocks, the fact is that during a transfer to external block-based media the same issues will arise. In particular, during the transfer such as over a network utilizing a object-based host to a remote block-based client it can be beneficial to optimize the network transfer process in order to prevent a noticeable delay in the receipt of the transmission. In fact, the entire transfer process could take significantly less time when optimized, in comparison to an unoptimized transfer process that simply moves data from one location to another location.

All of the above methods relate to increase the homogeneity of data blocks in regard to access speed and by that regard, type of data. The increase in homogeneity of a data block leads to a strengthening of the locality of reference for that data. The reason for this is the data blocks that are made up of the same type of data are more predictable than data blocks made up of randomly allocated data. This leads to an additional method unique to this invention in comparison to already existing methods. In particular, the utilization of variable block size to strengthen the locality of reference. By utilizing variable block size, the data blocks themselves can be terminated at the end of the data that fills the block, rather than the block needing to be filled to a certain point. At the same time, pre-existing blocks can be filled with the homogeneous types of data. Regardless, the potential for smaller blocks filled with homogeneous data also strengthens the locality of reference due to the fact that locations around a bit of data are more likely to be accessed after that bit of data is accessed. With a smaller block size, the more accurate this predictability of access. In should be noted that this predictability for data access applies to the processor. In that regard, smaller block sizes have disadvantages for storage devices due to the loads that small blocks place on storage hardware. That is why the balance between block size type and total system performance and longevity. This is also why the first step to increased performance is to increase the homogeneity of the data blocks in order to strengthen locality of reference in order to optimize data operations.

It should also be noted that while the above language refers to the processor and processor attached memory of the system a special hardware device could be created for the sole purpose of optimization. In this regard a system on chip could be created or some other type of hardware that interfaces through a high bandwidth interface with the system to handle any and all optimization requests that occur. In cases that involve such a specialized hardware device it is entirely possible to handle higher access speed requests up to the L3 cache speed. However, it is also possible that such a device would still not be able to handle references from data in the L2 and L1 cache. At the same time, such limitations would depend more on system specifications and the bandwidth the specialized hardware is able to utilize. Utilizing only the main system there is no work around as the access speed tops out at the L1 Cache and there is a limited amount of the L1 cache. However, in a theoretical scenario where a hardware device could emulate L1 cache speeds and be attached to the system any and all optimization requests could be handled.

The map of data blocks is then correlated to file system locations.

A performance test of the data composing said blocks is performed to determine the input/output per second capabilities of the data. In addition, a performance test of the data blocks is performed to determine if there are any inefficiencies relating to the overall length of time to conduct an operation on the entire block based on the amount of time required to conduct an operation on the data. Preferably, if an inefficiency is detected in the data block, the system determines whether reallocating the data of the data block would be successful; and also determines whether sufficient system resources are available to successfully reallocate each data block requiring reallocation. Preferably the system also determines whether reallocation would increase a level of performance of the system. If sufficient resources are available and if reallocation would increase said level of performance, the data is rearranged into blocks of consistent input/output speeds based on the data block map

A generic data visualization application like the one depicted in FIG. 14 will allow users to determine multiple different allocation options, or simply allow the program to determine what is the best allocative method in any given circumstance. This is particularly true if the program were to incorporate an artificial intelligence or machine learning framework. Outside of a generic program application the API 1354 can be tied into specific program applications for example image editing software, to more efficiently allocate data based on the particular needs of the software which the API 1354 is attached.

A generic program application graphical user interface (GUI) 1400 is shown schematically. GUI 1400 incorporates some of the methods detailed in the invention. A menu bar 1402 can be used by a user to change some of the reports or make selections to configure how the program application will implement some of the methods in this invention. For example, the user can edit a setting that triggers how long the period of time is for the program to detect data that is requested for in similar periods of times. Instead of the program looking for data that is requested for within 200 ms the user can set it higher or lower. This is one of many settings the user can change.

Optionally the number of requests becomes important for determining storage behavior by detecting a number of requests for the same data in a specific time frame that is over a threshold. The threshold number of requests can be set by the user as described above. Next, the program application and/or system may determine whether placing the data receiving the requests in a higher performance storage or memory that is higher in a memory hierarchy would increase efficiency of retrieval. If this placement would increase efficiency of retrieval, then the program application and/or system would determine whether the higher performance storage has enough storage space for the data. If the storage has sufficient space, then the data block would be moved to the higher performance storage.

If the higher performance storage does not have sufficient space, a highly local reference to the data block is created, and is then stored in the higher performance storage.

On the other hand and also according to the threshold set by the user, if the program application and/or the system determines that the data block is no longer receiving an over the threshold amount of requests, the data block would be moved back from the higher performance storage to a lower performance storage.

Reference 1404 is a generic picture that schematically represents information about the current memory storage device the user would monitor in the GUI. This picture can change depending the type of device that is being monitored. References 1406-1410 are all pie chart diagrams that graphically depict some percentage of the storage device's resources that are actively being used. This can be device utilization for access speed, storage, or some other resource. References 1412-1414 are line graphs depicting the utilization of some system resource over time. These graphs serve as an extension to the Venn diagrams, shown as references 1406-1410, allowing the user to gain insight into how their system is performing at any given time.

GUI 1400 allows a user to edit the settings for the API that controls how the system's data is allocated. The program also allows the user to visualize the performance of the system, and see whether the new allocation methods are effective.

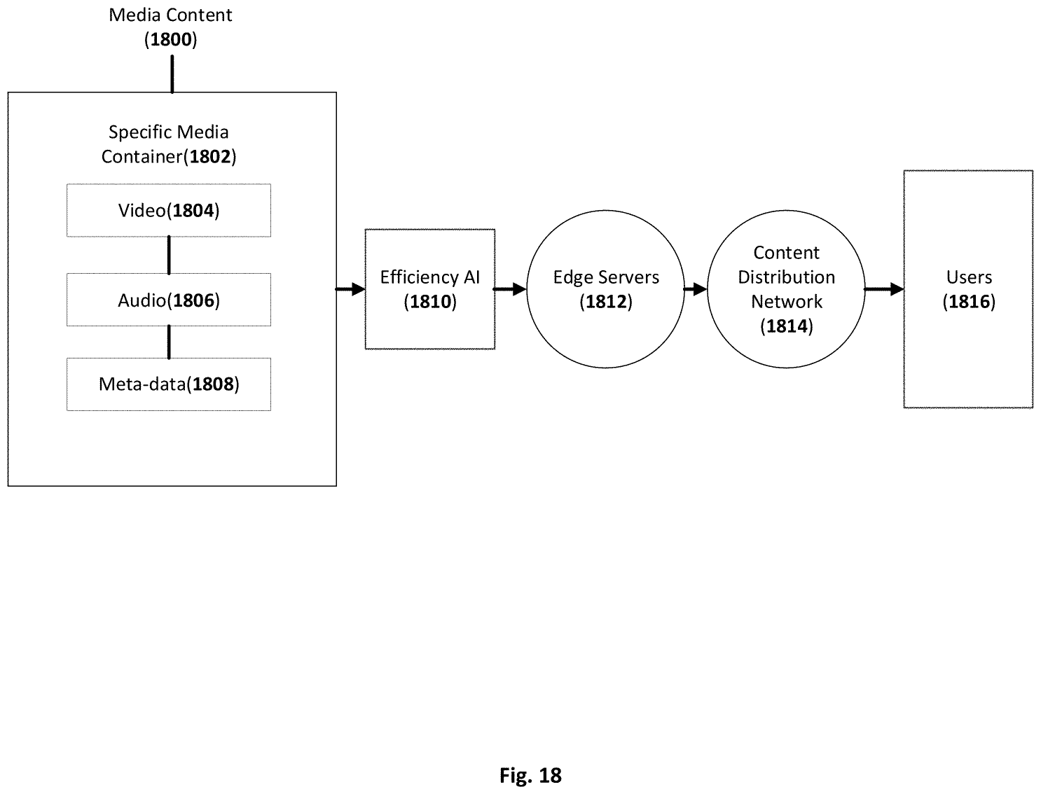

FIG. 18 expands on FIG. 14, FIG. 13A and FIG. 13B by illustrating a specific example of a Content Delivery Network (CDN) utilizing an efficiency AI based on some of the embodiments of the present patent. The claims of the patent could be used in a variety of cloud-based systems, but, for purpose of illustration a CDN is used due to the particular nature of multiple media types being sent to different destinations. A generic media container 1800 may contain any combination of media types. In contrast, a specific media container 1802 contains a particular media type, in this instance taking the form of a film that would be streamed to many different countries. Inside any specific media container 1802 is a wide array of different media files, within this example is a video file 1804, an audio file 1806, and a meta data file 1808. The reason for the three types of file is due to the ability of a content delivery network to deliver the movie across the world. Whereas the video file itself most likely will not change from country to country, the audio and meta-data will change depending on the country.

The method in this non-limiting example relates to the distribution of the media container to the broader content delivery network. The reason for this is that the content delivery network needs to broadcast (transmit) all available data at the same time, otherwise there would be issues with the display of the media type. For instance, in the case of a film, if the audio arrived before the video the end user would only hear the audio portion of the film's content, but would be unable to see the video portion of the film's content. Therefore, in the instance of content delivery to the customer it is important for the data to actually be transmitted at the speed of the slowest data that way all content is perfectly synchronized. On the other hand, when the media is sent to edge servers this process in particular can benefit from an efficiency AI 1810 as seen in the process from 1810 to 1812. An efficiency AI in this instance means an automated system that takes into account cloud resources and optimizes the transfer of media content so that it achieves the soonest transfer of the content. This benefit comes from the fact that the edge servers' primary goal is in the decreased latency to the end user. By decreasing the overall time it takes to send the entire media container to an edge server the AI 1810 helps to decrease the total latency to the end user 1814, even if it does not directly affect the latency of the CDN to the user.

While a person knowledgeable in the art would recognize that the content delivery network would encompass all the aforementioned parts, the purpose of splitting these parts up in a general, exemplary manner is to primarily illustrate what parts of the CDN would benefit from the methods described. However, the methods described herein may be implemented in a CDN in ways that this example does not cover. A further example of a novel way the methods described herein could be used in a CDN is in the reverse. Instead of increasing the access speed, when the CDN transmits to the user the invention could be utilized to ensure that every bit of data arrives at exactly the same time. Delaying transmission is not a novel concept, but varying the transmission based on the underlying access speed of each bit of data is an enhancement on the underlying concept and has not been described previously.

FIG. 3 is a flow chart depicting an exemplary, non-limiting method for detecting and optimizing temporal inefficiencies according to at least some embodiments of the present invention. A temporal inefficiency may optionally comprise one or both errors or inefficiencies in data that is accessed in a similar time frame to a particular piece of data, which results in non-optimal access speeds. Data that is accessed in a similar time frame, for example 200 milliseconds or less between requests, may be requested in a manner that actually results in significantly slower access speeds to the requested data. Another non-limiting example occurs when a particular data block has non-optimal access speeds due to errors or inefficiencies of the corresponding bits that make up the block. While the two inefficiencies are related to each other, they are also very different as overcoming the first is performed by optimizing the data block, while overcoming the second is performed by optimizing a smaller piece of data. Despite having different goals FIG. 3 shows that both objectives can be accomplished with a similar process.

The flow 300 starts with an I/O transaction being received by the system, such as the system described with regard to FIGS. 13A and 13B for example, at 302. Receiving such a transaction may optionally occur at multiple levels. For example, as described with regard to FIG. 13A, the system may be operative to receive transactions at the firmware level. Alternatively, as shown in FIG. 13B, the system may be operative to receive transactions at higher levels such as the application level.

The previously described instructions or program application (described herein collectively as the program), once deployed, can be activated to monitor I/O in real time as shown in step 304 or can be set to monitor during specific periods depending on user preference. Steps 302 and 304 may optionally be performed according to any process in any following figure that states “I/O TRANSACTION RECEIVED BY FILE SYSTEM” and “PROGRAM BEGINS MONITORING REQUESTED DATA”

At step 306, the program begins to detect temporal inefficiencies according to the two types of temporal inefficiencies already documented. Temporal inefficiencies are detected by monitoring activity over time as the name suggests. In order for the program application to detect temporal inefficiencies the program application needs to obtain its digital map of data within the data block and the access speeds of the data within the data block. This is so that the program application knows whether a piece of data is actually within a given data block or in another data block. The actual detection of a temporal inefficiency does not require the access speed map, as the program application can monitor and observe an inefficiency happening in real time. However, especially in an active scan the program application can find a potential inefficiency by scanning a data block while it is not being accessed. Regardless, the detection of inefficiencies is preferably performed after the program application has created maps of the system with which it is interacting.

Following the first type, the program would monitor how data is accessed in a similar time frame. An example of this would be during the operations of an application, or during a query. If the program detects that the data that is being accessed could be optimized so that the program or query can run faster, it will mark the data for optimization. Given that type 1 temporal inefficiencies result from data that is accessed in a similar time frame how the system optimizes for these issues must differ from type 2 inefficiencies where the solution is to only reallocate blocks. Type 1 inefficiencies are more troubling in some regard as the inefficiency can be cause by the usage of data from multiple blocks. For example, in a firmware setting such as in FIG. 13A the CPU 1304 will begin to monitor interactions between 1308 and 1318 to detect bottlenecks between the requests and the fulfillment of those requests. If there is a bottleneck detected the host system will begin to investigate the data storage device 1312 to detect where precisely the bottleneck is occurring. Once the location of the bottleneck is determined, the CPU in the host system will begin to determine what is the most efficient allocation of data based on currently available resources in 1312. This process will utilize the testing methodology mentioned above, once this process is complete, the CPU will send instructions to 1308 so that the processor in 1312 can begin to reallocate data in the optimal manner detected by 1304.

For the second type of inefficiency the program would monitor a specific data block and would detect whether the bits within the block are allowing the data block to be optimally accessed. The program would monitor how amount of resources, both computational power and time, and determine whether the data block in question is utilizing more resources than a block made from specific types of data. The program will take various samples of the bits inside the monitored block and use that to construct virtual models that will exist as a test set that the monitored block will be compared to. By comparing the monitored block to blocks constructed of the same types of data within it, the program has a realistic set to compare, rather than attempting to compare the data to an ideal state and attempting to correct for issues that cannot be solved.

For example, as described with regard to FIG. 13, once a user has configured the firmware for the host 1302 to the CPU 1304 located in the host system 1300, the CPU 1304 will begin to monitor the data storage device 1312. The CPU 1304 monitors device 1312 instead of the requests from memory storage interface 1308 to host interface 1318. This monitoring of device 1312 is due to the fact that the particular allocation of bits inside the data blocks causes type 2 temporal inefficiencies, whereas type 1 is caused by a myriad of different issues. If there is a data block that is detected as being accessed slower than it one of the virtual blocks than that data block will be marked for optimization. It does not matter where this block is stored in the data storage device, as the suboptimal allocation of bits within a data block can cause access speed issues across the whole device.

After the initial scan to determine whether there are any temporal inefficiencies there are two paths the program can take. If no inefficiencies are detected, then in step 308 the program would not make a correction. Optionally, if the inefficiency is detected to be not statistically significant the program can make no changes instead of utilizing resources to solve minor problems. Statistical significance will be detected by actively comparing the incoming data with the virtual models that were constructed by the program. The virtual models will serve as the null hypothesis for the program to test against, and if the access speeds for example align perfectly with the virtual models the error does not pass the null hypothesis and nothing will be done. The program will use a well-established significance level of 5% to determine whether or not to make any corrections. However, this value may be changed by users of this invention to a significance level more appropriate for their use cases, and/or may be changed automatically according to analysis of system dynamics and/or specific use cases.

If however inefficiencies, or sufficient inefficiencies, are detected, then in step 310 the program begins to correct for temporal inefficiencies. At this step, preferably the program first checks for data that is currently in use, as the program preferably cannot make any alterations to data that is currently in use, as that would result in memory reference errors in whatever other context that data was being used.

Once the program determines that the data is safe for optimization it begins the process by determining what data is causing the bottleneck in step 312. Due to the program determining what type of temporal inefficiencies exist due to monitoring in 306 the program can immediately begin to test the data the is causing the first type or the second type of temporal inefficiency. The tests performed in 312 are necessary to determine the exact extent of the bottleneck and what level changes are necessary. At this point the program may optionally operate in a partially manual manner, by displaying the affected area to a human user and recommending an optimization. Alternatively and preferably, this process can be completely automated.

By testing the extent of how many bits are affected in step 312 the program can determine whether to completely extract the affected area and move it into a new data block in step 314. This process affects type 1 inefficiencies in particular as the number of affected bits, and the size of the data block they are stored in may make creation of new data block more effective than attempting to edit the existing data block. Conversely, if the affected number of bits is small, then it is possible to reorganize the existing data block to be optimal. In the same vein, when there are temporal inefficiencies of type 2 and the entire block is affected, then it is preferable to begin the process of removing all bits and creating new blocks made out of consistent types of bits in step 316. The optimization method that is most effective given the constraints detected will be the one utilized. However, preference will be given to recreating blocks of consistent types of data as this has been found to resolve many issues regarding access speed and thereby decreasing the likelihood of temporal inefficiencies. The entire process detailed in FIG. 3 may also use further methods detailed in further figures such as the ability to include a reference in volatile memory to the new location so that a program does not have to be pointed to the new location in storage which would be an issue for programs created with a low-level language.

FIG. 4 relates to an exemplary process for determining whether data is to be stored in volatile or non-volatile memory. The process 400 begins with receiving an I/O transaction by the file system in step 402. Again, the file system may optionally be implemented according to the systems of FIGS. 13A or 13B, or as any other suitable file system. The program as activated in step 400 will scan the current file architecture in order to determine the resources it is working with. However, it will preferably not actively start monitoring data operations until it detects that data is being actively requested and retrieved, in order to save computational power when it is not required. In essence, if the system is sleeping, the program is also sleeping.

At step 406 the system determines whether the data requires a higher memory hierarchy by detecting the frequency of TOPS and comparing that to the scanned technical limitations of the memory devices attached to the system. If the program detects that there is a higher request frequency for the data than what the current memory storage can physically supply, the program will look to see if there is storage space available at a higher memory hierarchy level. If such space is available, the program will move the data temporarily there so that it can supply the data at the rate it is requested. If there is no space available, then in step 408, the data remains in, or else is transferred to, non-volatile mass storage. If the data does require a higher memory hierarchy, then in 410, the system begins the process of sending a reference to the volatile memory. This process allows other programs to utilize data that has been moved by the program without the user needing to point the other programs to the new memory address. However, if there is a need for volatile memory, then the program will account for whether there is enough space to store the data directly in the volatile memory 410. If there is enough space, then the data is stored directly in the volatile memory in step 412.

Storing the data directly in volatile memory in step 412 comes with several benefits in regard to access speed of the data. Regardless of how the data is being accessed, for example, editing versus querying, the data can be accessed more frequently while in volatile memory. If the program detects that there is not enough storage space in the volatile memory for the data to be sent directly to the volatile memory, the program will instead send a reference to the new location for where the data exists on the non-volatile storage in step 414. While access speeds will be lower, this will allow any other programs to proceed to utilize the data they were referencing before step 414 is performed. This is intended to fulfill other programs resource requirements until the system is reset and the programs can target the new locations. In systems that are infrequently reset, and without wishing to be limited by a closed list, the program has advantages in decreasing overall downtime while still performing file system maintenance that would increase system effectiveness.

FIG. 5 is an exemplary block diagram showing how data can be tail packed into a data block, or how slack space can be utilized in a data block. While it is known in the art to use slack space in a data block, the system and method as described herein provides a particularly preferred method for implementing slack space. Preferably the method features using slack space by filling it with consistent types of data. Blocks 500-506 are references to non-limiting examples of the types of bits that are within the data blocks 508-512. Block 500 includes text data, block 502 includes image data, block 504 includes music data and block 506 includes video data, as non-limiting examples. At a machine level the program cannot differentiate between what is a video file compared to what is a text file. However, while monitoring the file system the program is able to learn based on system activity, a broad class of interactions the system has with the data being monitored, and that there are different bits that are broadly related to each other in how they are accessed. The process to determine what bits represent what types of files at the firmware level is similar to the process detailed in 306. However, the process described in 306 is preferably expanded to include collecting sample data from the storage system being monitored, then using this sample data to determine standard access speeds for various types of file objects. The program itself cannot differentiate between different types of files as a human would, but it can detect different file types and label them as separate objects within the program. The program would utilize access speeds, and general bit size characteristics, along with what types of data are accessed in a similar time frame, among other variables, in order to determine what types of files the data represents.

As a non-limiting example, in the case of the firmware system described in FIG. 13A, the CPU 1304 would regardless of the type of temporal inefficiency, monitor data storage device 1312 in order to begin the characterization of the data held within device 1312. After a map of the data blocks is constructed the program can initiate code that will efficiently pack the data blocks in a way that makes the most sense according to the system map. It should be noted that the mapping can take place at the same time as the reallocation of data blocks. However, they are different methods requiring different techniques, and resources.

The system involving program application illustrated in FIG. 13A would work roughly similarly as the firmware program at the API level 1354, shown in FIG. 13B. However, the program application 1352 would have an advantage in some regards compared to the firmware program, this is due to the fact that the program application 1352 has direct access to the file system. The program 1352 via the API 1354 can read directly what file type is assigned to any given data type and use that as a common ancestor object. However, the firmware program and the API 1354 utilize a more sophisticated methodology for determining file type, so that mislabeled file types, and subsets of filetypes can be detected. For example, not every image file type utilizes the same resources, based on factors like encryption, compression, and several other factors. The more sophisticated methodology used to detect file types would be able to sort out for example different levels of JPEG file type, or, even be able to detect a native PNG file that has been cast as a JPEG.

Based on what the program 1352 is able to learn from system monitoring, it is able to construct object classes, and furthermore, objects under those classes that would exist as a file type. Doing this the system would have, in essence, a map of sorts of how the data blocks are constructed with what classes of files. For example, the program would be able to find all bits of data of the class video and would further be able to delineate between objects in that class so that there is no corruption of the data being rearranged simply due to it being of the same class. That is why, turning back to FIG. 5, a smaller data block 510 comprising video type bits is added to a larger data block 508, as there are already video bits of data in larger block 508. By adding smaller data block 510 to larger data block 508, consistent types of data are stored together. Furthermore, this process would create a block that would have a more uniform access speed. In the new larger data block 512, the new data added from smaller block 510 is preferably kept separate from the old video data that existed in larger block 508. The process at a system level for a firmware application would follow the process for detecting inefficiencies and file types, as the file type mapping is necessary for the reallocation for data blocks. Once the map is constructed and the instructions are sent from CPU 1304 to the Processor 1314 of FIG. 13A, for example, the next step is keeping track of all the changes that are occurring so that the file type bits are not randomly allocated. The random allocation of bits is one major issue the invention seeks to resolve as this random allocation results in many of the issues detailed in the background.

The monitored allocation takes place in any memory storage location within data storage device 1312, such as for example a memory associated with processor 1314, volatile memory 1320, or non-volatile memory 1322. Utilizing the previously constructed map of bit file types, the firmware program will make sure that any available slack space is not packed with a file type that is different from the data that surrounds that slack space. This will prevent corruption and memory overflow errors when dealing with data types that may be used as resources in programs.

Optionally, the process in FIG. 5 can also be expanded with other techniques from this invention. For example, based on the number of bits that would be tail packed, and the number of bits that are already in a block, the bits of a similar type can be merged into a new block of only consistent bits. This would be in comparison to adding consistent bits to a block relative to other bits in a block.

FIG. 6 shows a non-limiting exemplary flow that demonstrates the process of how data blocks of consistent data types are created. In a flow 600, the process starts by having the program scan through existing data blocks in step 602. This initial scan optionally allows a program to optimize data blocks without at first needing to detect an inefficiency based on system usage. The program would run the test cases described in the FIG. 5 example descriptions in order to determine which blocks to optimize in step 604, according to the determination of the presence of inconsistent data types within the data blocks. However, the program optionally does not actively monitor the system in order to make this determination, but rather may perform this analysis periodically. After a potential optimization is detected, the program can automatically begin the process of optimization or send a notification to the user to request authorization for the optimization.

In order to optimize any given data block the program will first break down the larger blocks into smaller blocks of similar types of data in step 606. This process preferably uses the mapping technique outlined in FIG. 5 in order to determine what are the consistent types of data. After the larger data blocks are broken down the program will determine if there are any available large blocks that are already made out of consistent data types in step 608. The reason for this being that the program will not need to issue any unnecessary commands to create new blocks if the program deems it is not necessary. If the program detects that there are data blocks available that have a consistent data types and have storage space available, the program will store the smaller blocks of data into the aforementioned consistent larger blocks. The reason for consistent data blocks is that the blocks will be accessed at uniform speeds thereby eliminating any potential bottlenecks. If the data is accessed in a series of blocks then all blocks will move at the fastest access speed available, instead of all blocks being accessed at the slowest speed due to the slowest bits making up the block determining maximum access speed.

If there is a large block with a consistent data type available, then in step 610 the smaller blocks are preferably packed into the large block.

If there are no large blocks with consistent types of data available, then the program will create new blocks for the small blocks to be stored into, in step 612. The reason this is necessary is that most file systems utilize a larger block space as the minimum storage capacity for a block. Therefore, if everything was kept as smaller blocks, the data would take up more storage than it needs. For file systems that allow variable block size, or allow smaller block size, the program can take advantage of this and store the smaller consistent types of data in a way that maximizes the resources available to the system.

The process in FIG. 6 will continue until all blocks that are detected to be not optimal are optimized in step 614. It is also important to state that the program will take into account current system needs and will adjust how it optimizes the data blocks based on any changes in system needs. For example, if over time certain data blocks are not utilized as frequently the program will prioritize optimization of storage space in comparison to prioritizing access speed which is largely what consistent data blocks aims to accomplish.

FIG. 7 further illustrates the process of how a program using one or more of the methods described herein would monitor system activity and optimize the data based on that activity, preferably in relation to spatial inefficiencies. Without wishing to be limited by a closed list, spatial inefficiencies also preferably have two types. A first type, type 1, relates to errors or inefficiencies in data that is accessed in a nearby memory location compared to a particular piece of data result in non-optimal access speeds. A second type, type 2, relates to a situation in which a particular data block utilizes too much storage space in comparison to an optimized version of that data block. The process 700 begins with an I/O transaction being received by the system in step 702 and the program beginning to monitor the data transaction in step 704. In step 706, the program begins to check for inefficiencies.

If no inefficiencies are found, then the system preferably takes no action in step 708, as there should not be any modifications if there is no detected need for said modifications. Preferably, the program will make a determination if an inefficiency is statistically significant as previously described before it makes a modification; if the inefficiency is not statistically significant the program will default to not modifying the system. If an inefficiency is detected the program will determine whether the inefficiency is the result of a temporal or spatial inefficiency in step 710. If it is temporal the process would preferably continue with step 310 of FIG. 3, if it is spatial the program would determine what type of spatial inefficiency exists in step 712.

Also, a person with skill in the art will note that type 2 spatial inefficiencies already have solutions in the form of tail packing. However, given that this embodiment of the invention seeks to optimize the file system by taking account of class 2 spatial inefficiencies, such inefficiencies need to be factored into the procedural logic of the invention. Step 714 therefore preferably seeks to resolve class 2 spatial inefficiencies by utilizing the already existing tail-packing method. Step 714 can utilize a known in the art tail packing method , or step 714 can utilize the tail-packing methodology that includes file type monitoring which is within in the scope of this invention. Overall, the goal is to utilize the slack space that is available to most efficiently pack data blocks with as much data as the file architecture allows, while maintaining system stability.

The flow chart denotes issues regarding small files as a type 2 issue due to the technical fact that small pieces of data could be taking up an entire data block. This issue is resolved using the standard tail packing method already mentioned. On the other hand, the flow chart denotes that issues regarding modification are a type 1 spatial issue; this is due to the fact that type 1 issues are a result of attempting to guess which files in a nearby memory location should be loaded faster in order to increase access speeds. Step 716 seeks to resolve type 1 spatial issues by finding the nearby files that are necessary for access and moving them to their own block. This resolves errors that can arise from the file system attempting to guess which nearby data would increase access speed if preloaded, as only files that are determined to be related would be put into the new storage block. As FIG. 3 described how to increase the locality of temporal references, FIG. 7 describes how the locality of spatial references is increased utilizing methods from the invention.

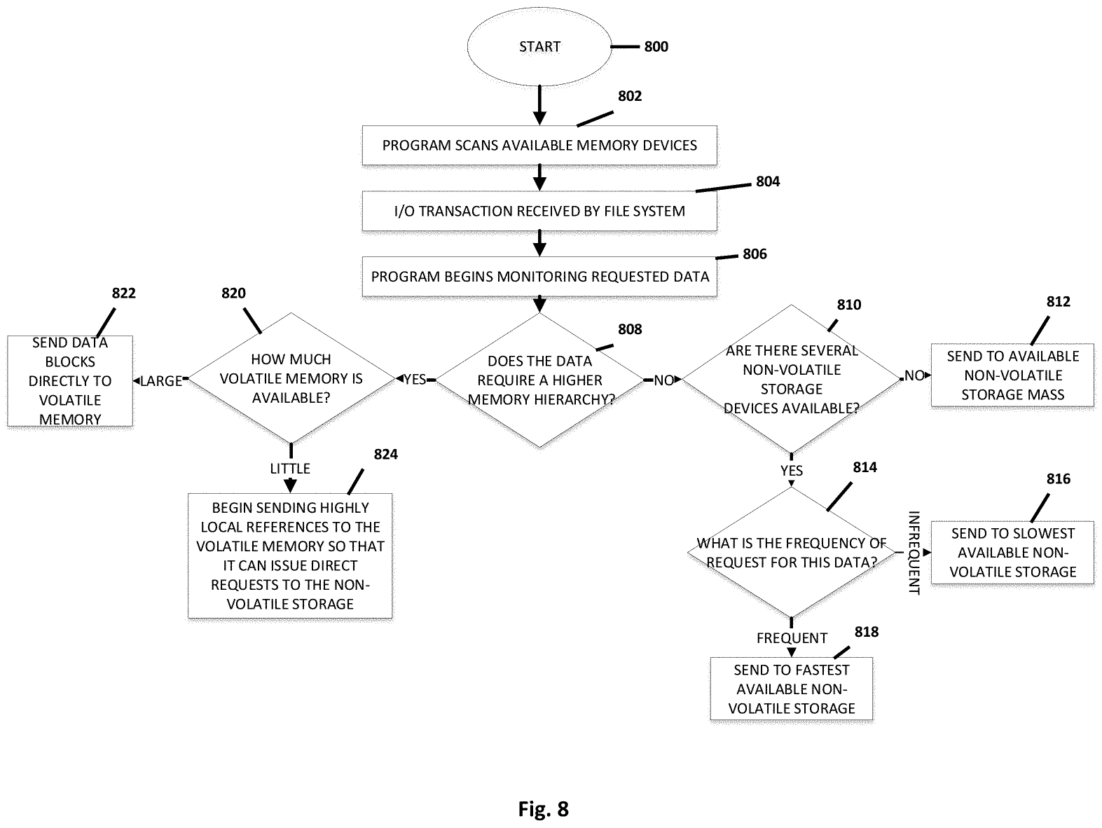

FIG. 8 describes a non-limiting, exemplary process for determining the optimal memory hierarchy based on current system needs. A process 800 begins at step 802. A program based on the invention first needs to scan the available memory devices so that it knows not only how much storage is available, but what frequencies the available storage devices operate at step 802. The program preferably operates as previously described in steps 804 and 806. In step 804, an I/O transaction is received by the file system. In step 806, the program begins monitoring the requested data.

In step 808, the program determines whether any given piece of data requires a higher memory hierarchy. The program will determine this by looking at the frequency of requests for the monitored data and based on a calculation the program will detect whether the current storage medium can fulfill those requests adequately, or if it serves as a bottle neck for the access speeds. After this the process preferably branches off into two separate trees in order to handle the separate cases of memory hierarchy based on availability of volatile memory in particular.

The program first determines whether the data needs a higher memory hierarchy in step 810. If not, then the program will begin the process of determining whether the data can be put in lower memory hierarchies. If the program does not detect multiple types of non-volatile storage during the initial scan from step 802, then the program preferably keeps the data in the non-volatile storage that is available in step 812. Conversely, if the program does detect that there are multiple types of non-volatile storage the program will then determine what level of access speed is necessary for the data based on the data it gathered from monitoring the frequency of requests in step 814. If there has been a large gap in time between requests, or there are infrequent requests for the data then the program will put the data into a block in the slowest storage medium available in step 816. The program selects the slowest medium available so that storage resources are less scarce for data that requires the faster speeds. To this end, data that does require faster speeds, but not the fastest speeds determined by the immediacy of need for the data, will be moved into data blocks located on the fastest non-volatile storage in step 818.

On the other hand, if the program does detect there is a need for the data to be placed in a higher-level memory hierarchy the program will determine the next step based on how much volatile memory is available in step 822. It should be noted that the program preferably does not explicitly attempt to place data into any of the processor's memory as there is the general assumption that the highest-level memory is fairly efficient. This assumption stems from the fact that the processor cache operates with the highest frequency, thereby, requesting, and flushing data at a high rate. What this should result in is that the processor memory is not expected to be in a position to be a bottleneck.

However, various embodiments of the invention and any program that derives from it can take advantage of memory space available at the highest-levels, it is generally not advised, but it is still a feature that can be taken advantage of. If there is enough storage space available in the volatile memory the program will send the data directly to the volatile memory for it to be accessed in step 822. However, if there is very scarce volatile memory available then the program will send highly local references to the volatile memory to save on storage space in step 824. This process would not allow the fastest access speeds for the data, but it is particularly useful in situations where the system is querying the data and particular data commonly fulfills the query requests. Instead of a slower performing query on the non-volatile memory, a faster performing query can be applied on the volatile memory and the highly local references can immediately point the query directly to the data on the non-volatile memory. The highly local reference process can also be applied to the processor cache from random access memory for example. Therefore, any resource scarce memory system can take advantage of highly local references from a more abundant memory system.

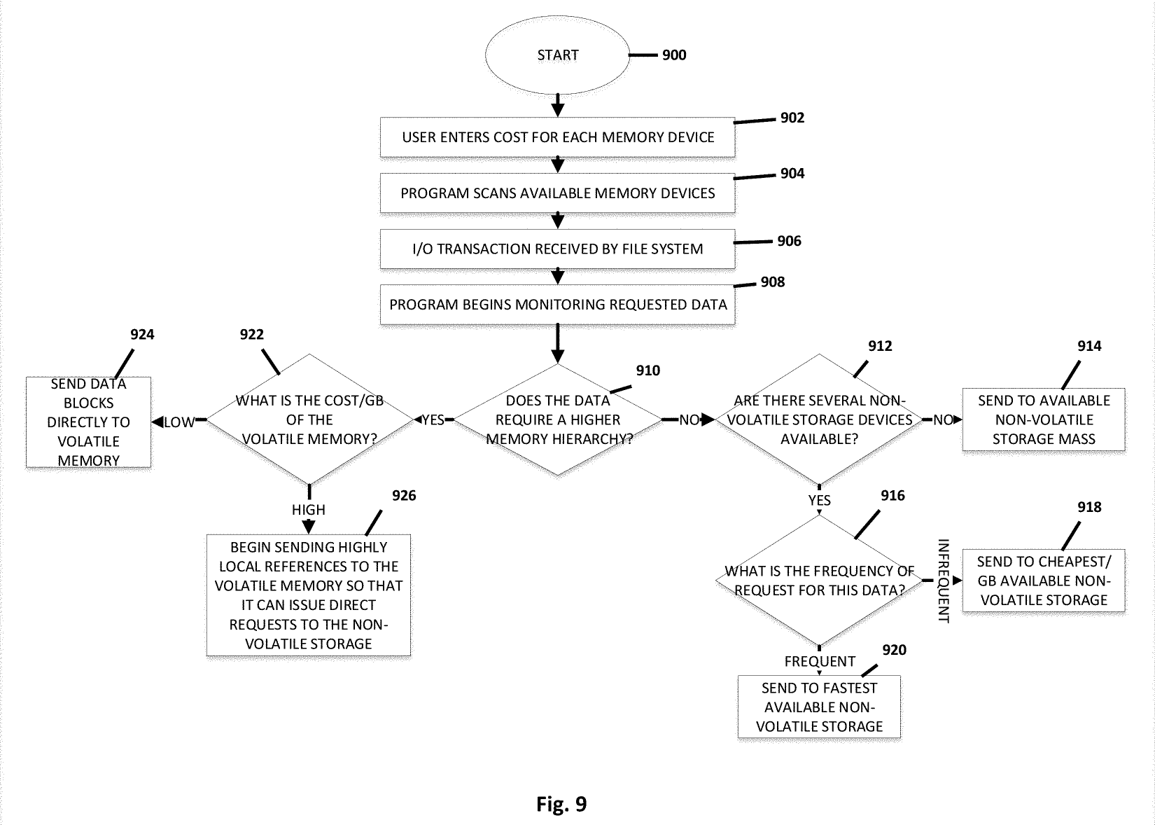

FIG. 9 shows a non-limiting exemplary process of accounting for cost structures when selecting an optimal memory hierarchy. A process 900 starts with the user entering the cost for each memory device, preferably per gigabyte, although alternatively the system can calculate cost per gigabyte based on total cost 902. Steps 904-910 may be performed as previously described. Step 904 features scanning available memory devices. In step 906, an I/O transaction is received by the system. In step 908, the program begins monitoring the requested data. The program preferably determines whether the data needs a higher memory hierarchy in step 910. If not, then the program will begin the process of determining whether the data can be put in lower memory hierarchies.

As for FIG. 8, the flow in FIG. 9 may now branch off into one of two branches. If a higher memory hierarchy is not needed, then in step 912, the program determines whether there are multiple non-volatile storage devices as previously described. If the program does not detect multiple types of non-volatile storage during the initial scan, then the program preferably keeps the data in the non-volatile storage that is available in step 914. Conversely, if the program does detect that there are multiple types of non-volatile storage the program will then determine what level of access speed is necessary for the data based on the data it gathered from monitoring the frequency of requests in step 916. If there has been a large gap in time between requests, or there are infrequent requests for the data then the program will put the data into a block in the cheapest per gigabyte memory device available in step 918. The program selects the cheapest available so that storage costs are overall lower. To this end, data that does require faster speeds, but not the fastest speeds determined by the immediacy of need for the data, will be moved into data blocks located on the fastest non-volatile storage in step 920.

While the slowest and cheapest memory devices are generally related older depreciated memory devices can be faster and cheaper than some tertiary storage options such as cloud storage. In this case a program based on the invention would preferentially allocate slower data to the faster storage because it was cheaper. At the same time step 920 is preferably expanded to the point where data will fill out the cheapest, fastest, non-volatile storage before being sent to the most expensive non-volatile storage.

If the data does require a higher memory hierarchy, then in step 922 the cost per unit, such as a gigabyte, of volatile memory is determined. The process for volatile storage is quite similar to the cost optimization of the non-volatile storage. If the cost per gigabyte of volatile storage is low, then the program will preferentially send data to the volatile storage when data requires the faster access speeds in step 924. However, if the cost per gigabyte of the volatile storage is high, then the program will preferentially send references to the volatile storage in step 926. Data in step 926 will only be sent directly to volatile storage if it is determined to be an absolute necessity and there would otherwise be a critical inefficiency by sending a reference. This is in comparison with FIG. 8 where data would be sent to volatile memory preferably based upon the systems need for this data at the time. A program based on the invention utilizing cost optimization would not just account for need and cost, it would also monitor how long this need is for. Therefore, if a certain piece or set of data needs a higher-level memory, but only for a small amount of time, there is no overall benefit to storing it in volatile memory as it would raise the cost of storing that data, whereas it is not utilizing that speed over a large enough period of time to benefit from it.

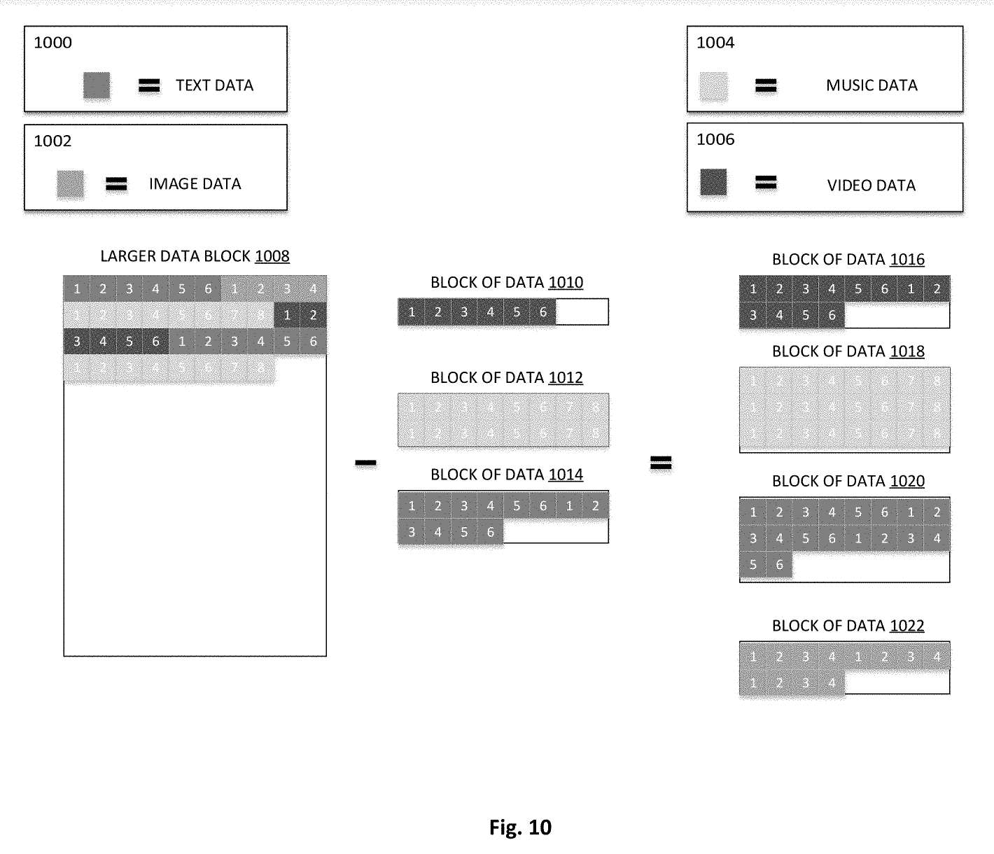

FIG. 10 expands the concepts from FIG. 5 in an exemplary implementation and showcases how a large data block with inconsistent data types is broken down into other blocks with consistent data types. A program based on this invention would first break up the original larger data block until there is only 1 type of data left within it, this block would then serve as a storage block for that specific type of data when that data is extracted from other blocks. The block labeled 1022 is what is left over from the operations after all other data types were extracted from block 1008. Other data was found from other blocks and was added to the remainders from block 1008. The process to break down the larger block is show via the subtraction of blocks 1010, 1012, and 1014 from block 1008. The process also utilizes the same mapping technique that is utilized in FIG. 5 that allows the program to figure out what types of data exist within any given block.

The process of breaking down block 1008 results in the blocks 1016, 1018, and 1020 which also find data of similar types to construct even larger blocks of consistent data types. The reason for constructing the larger blocks is the same as in FIG. 6, the larger blocks allow the most efficient utilization of storage space. The process detailed in FIG. 10 can be utilized alongside other methods within the invention to accomplish a wider set of goals.

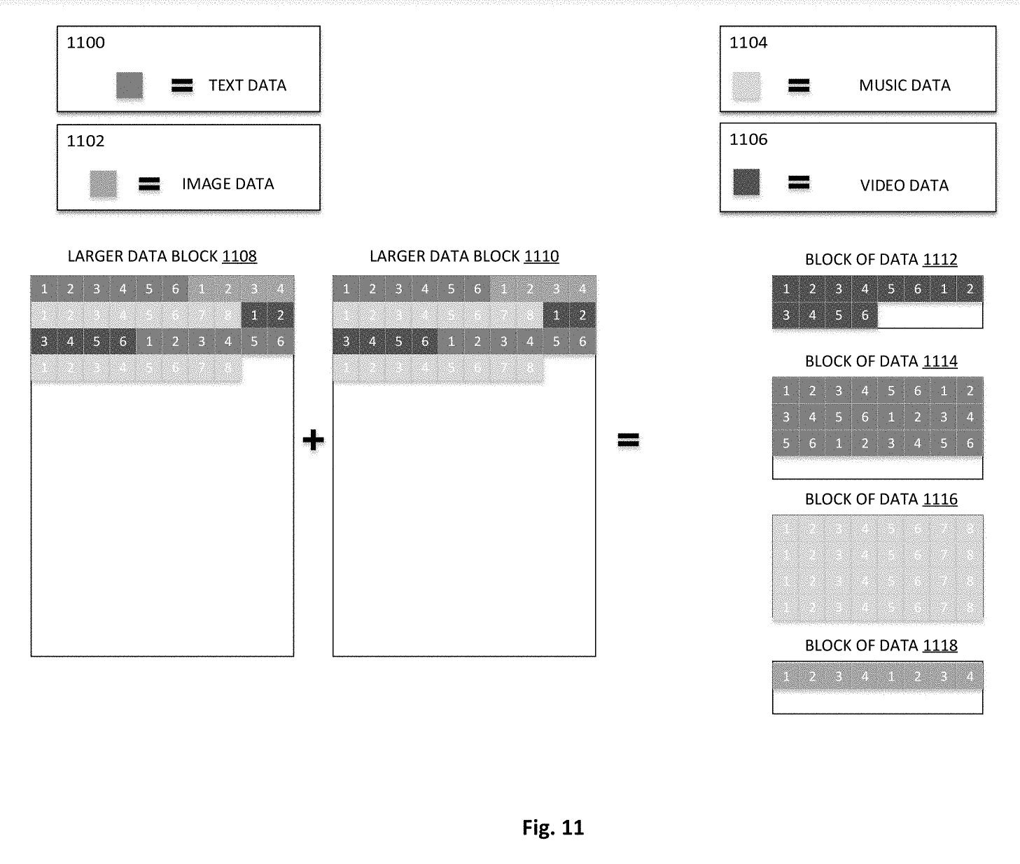

FIG. 11 takes the concepts illustrated in FIG. 10 and expands on their details in an exemplary implementation. For instance, in FIG. 11 it becomes readily apparent how data is added together from different large blocks to create consistent smaller blocks. In this respect FIG. 11 is focused on maximizing the access speed capable for each block by creating blocks of consistent types of data. The total data in blocks 1108 and 1110 is analyzed and then the large blocks are broken down into their base components. The base components are added back together into new blocks with consistent types of data blocks 1112-1118. The consistent types of data will mean that for instance music data which has different properties than video or text data, would not slow down a faster data type. In another example this also allows the data block to be queried much more efficiently across a more massive set of data, when data types are consistent it is much faster to parse, and index.

Optionally, in this method or another method as described herein, increasing the locality of reference comprises subdividing a larger data block into smaller blocks, which may for example be of consistent types as described herein. Next the smaller blocks are preferably tagged with a unique identifier so that the file system reidentifies data that has been physically moved and so that the file system interprets the smaller blocks as being collectively part of a larger set based on the unique identifier.

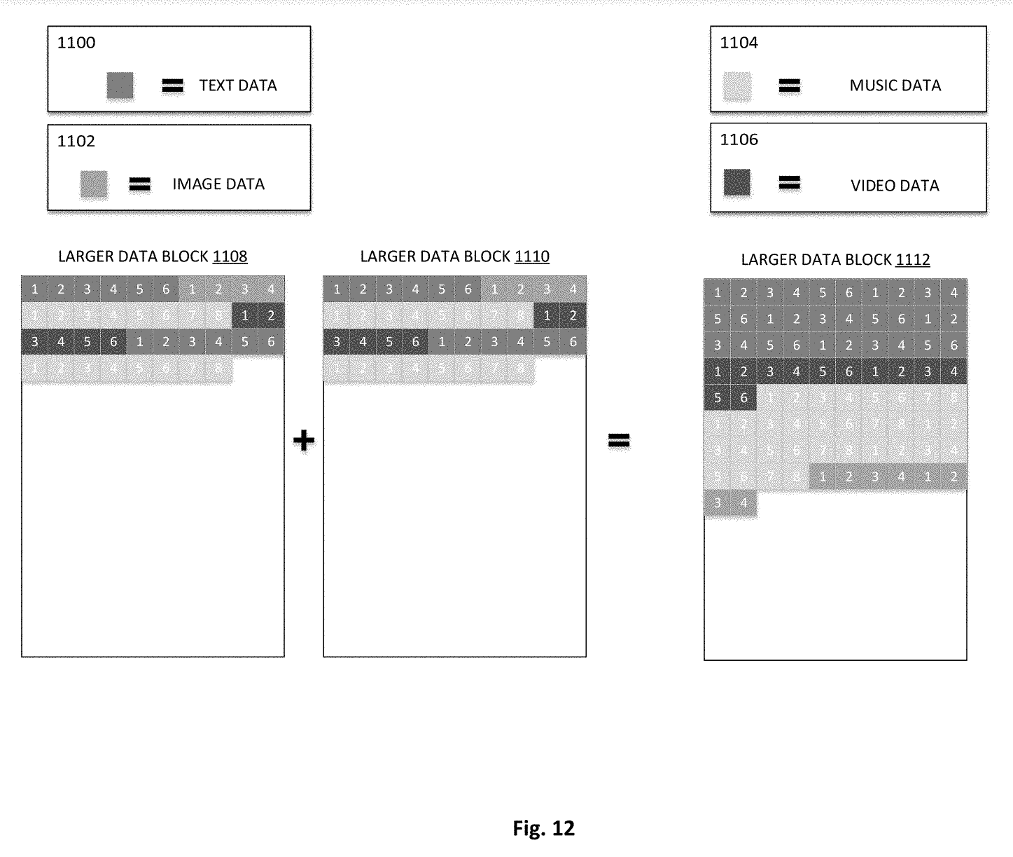

FIG. 12 combines many of the methods showcased in previous figures into one block diagram. While FIG. 12 is mainly showing how storage space would be optimized within a data structure it also utilizes consistent data type tail packing so that access speeds are moderately increased compared to only tail packing by storage space available. While tail packing already exists as an art known technique, FIG. 12 shows an improvement on that technique by selectively allocating data based on what type of data as is seen in block 1112. This also allows further corrections using any of the methods present in the invention or illustrated by the figures herein. For example, if a user wants even greater access speeds it is much easier to break apart a data block into consistent data blocks when the internal organization of the original data block is relatively consistent. Beyond this, it is much easier to solve for and even prevent errors when it comes to problems regarding locality of reference when all the data within the block is already organized in a much more logical manner. In effect, FIG. 12 showcases an optimized base state that can exist within a system's file system. This base state can then be used to much more easily correct and detect any issues or issue optimizations that a user could want.

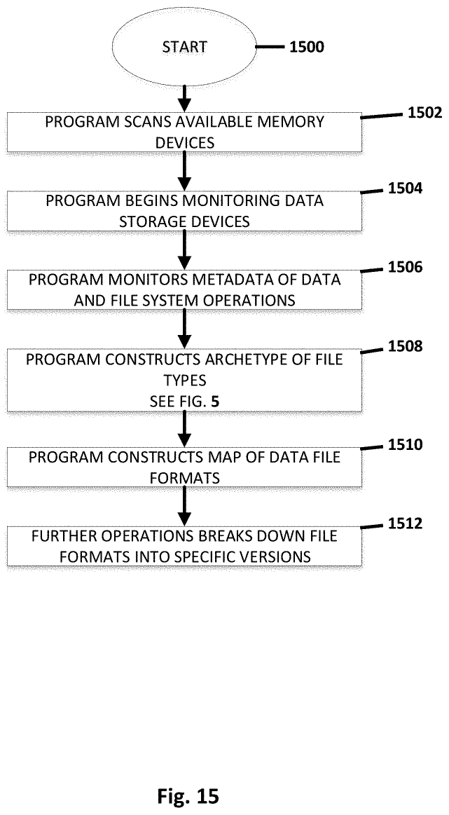

FIG. 15 expands on the block diagram of FIG. 5 by illustrating a non-limiting, exemplary process that a program may take to determine the file formats of different data objects at the data storage level. This method can be utilized with the file system in order to check for accuracy, and aid in the construction of archetype file formats as is described in the FIG. 5 example. For example, at step 1508 a program application such as one depicted at the system level in FIG. 13B, would utilize the API 1354 in order to request string objects from the file system for all file formats. These string objects would be utilized to seed the archetype files formats mentioned in 1508. The string objects would be matched to files that have this string in their metadata. A sample of these matched files would be used to determine the standard digital finger print of a given file format. In further example, storage space utilized, read access speed, write access speed, CPU utilization, and other characteristics would be factored into determining a standard file of a certain format.

Once the system is able to determine what constitutes any given file format, the system will take the ancestral map of file types such as the one created in FIG. 5 and update the map with the file format of each bit. This process is achieved by monitoring specific variations between broader file types. For example, within the broader video file format there are different encoding standards such as H.264 or H.265 each of these encoding standards has a different digital signature when it comes to system resource requirements that when monitored creates a pattern that can delineate between different encoding standards. For the end user this delineation between encoding standards is presented as a difference in quality among other things. However, for the machine this difference is indicated by access speeds, bandwidth utilization, and other system resource factors. By breaking down general file types into more specific container formats this will allow the system to create a more specific optimization profile based on the consistency of specific container formats rather than rougher optimization based around estimates of file types such as video, audio, document, etc.

Further analysis of the file system and data operations can determine the specific version of any file type, for example H.264 vs H.265 encoded MP4 files can be detected based on further monitoring and increased levels of data mining by finding discrepancies between the generic MP4 standard digital finger print, and the specific version digital finger print. Once there is a sample for the system to compare to, the system will automatically tag each specific version of a file format at a bit level so that the system can create optimization profiles based on extremely specific bit level maps.

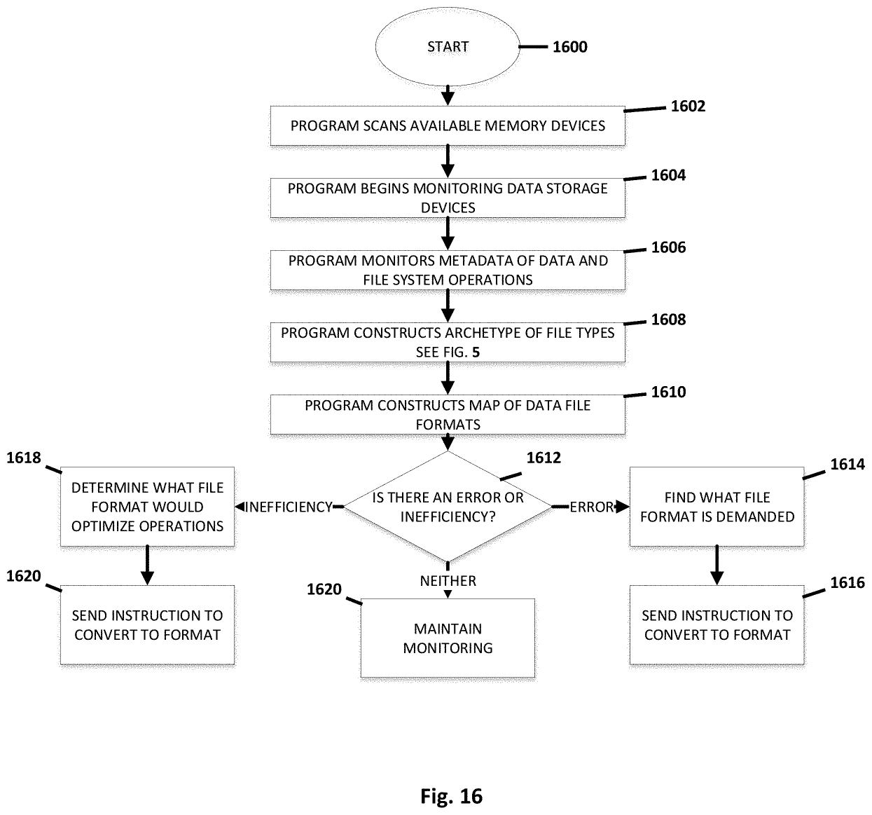

FIG. 16 further expands the process detailed in FIG. 15 by showing an exemplary process to correct for file format errors. These errors may be detected and corrected by utilizing the detailed bit level map created by the system in FIG. 15. After the map is created in step 1610, the system will check if there are any inefficiencies or any errors in regard to file formats. The method to determine file format error differences at what level the program exists, for example, at the program application level such as in FIG. 13B, the API 1354 can interface with an operating system of some sort, this operating system can directly pass any file system errors, or access errors directly through the API to the program application 1352 in order to easily catalogue if a file format error has occurred and where it has occurred.

At the firmware level such as FIG. 13A it is much more difficult to detect file format errors as at that level file formats do not technically exist. This issue is worked around by utilizing more monitoring, as the host system 1302 monitors the interactions between 1308 and 1318 the host will detect if there is a request for a certain amount of data, and when that request is attempted to be fulfilled there is a rejection. Since the host system will have a data map from the process detailed in FIG. 15, the host will check the bits that form the data tag to determine if they match what the requested data tag should look like: step 1614. If the rest of the data block looks correct, and the tag looks incorrect, the system at a firmware level can make a correction to the data block for file format conversion: step 1616.

In comparison to file system errors, inefficiencies utilize the previous methods outlined throughout the rest of the invention. In comparison to the difficulty to file system errors, the inefficiencies are easier to detect at the firmware level as the system does not need the initial step of checking the tag to figure out if there is an inefficiency. The system will then utilize the archetype store of file formats to compare the given data block to a block made up of various bits of similar file formats: step 1618. For example, if the system detects that there is a a set of data blocks made from H.264 MP4 bits, and it detects that H.265 MP4 bits would create more optimized data operations the system would mark these blocks to be converted to that format: step 1620. It should be noted that the system will preferably only convert the file format if: A. the system has been authorized to do so in an automated manner, and B. the system has the proper resources in order to complete the conversion. For example, if the system does not have the encoding resources necessary to convert a file format, it will mark the file to be converted, and this would be a visible flag in a program application, but the file will remain unconverted.

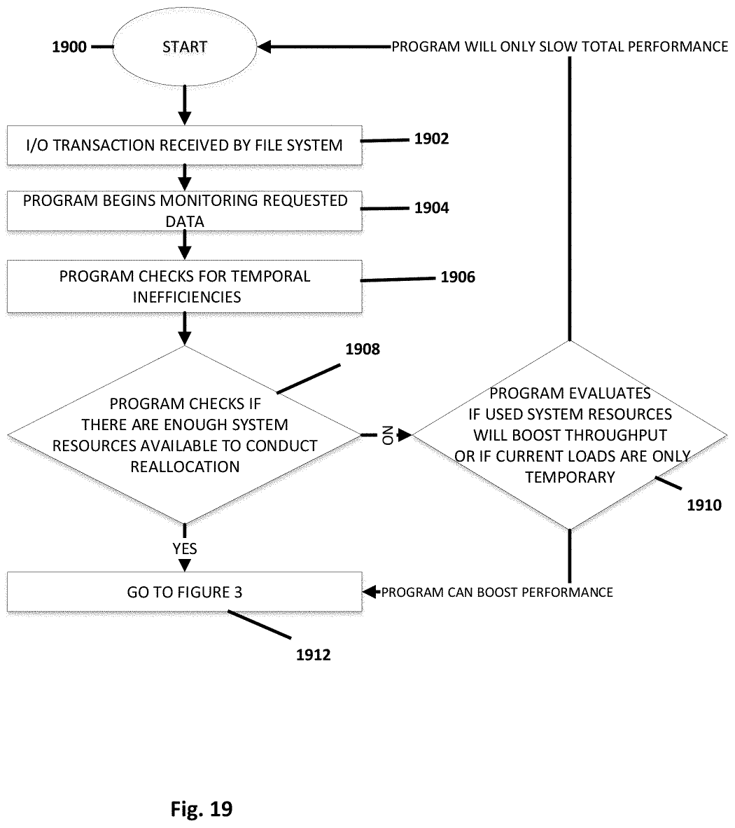

The methods described herein may also feature a variation that reduces or prevents system failure caused by the implementation of such methods. FIG. 19 is a flowchart that illustrates the logic behind the error checking mechanism. One challenge that the methods described herein encounter is one of resource utilization. This is due to the fact that memory corruption prevention is part of the system by nature of how it operates. On the other hand, because the system encounters large amounts of data and variables the system will require a proportional amount of computational power. Optionally a method may be implemented that can aid in data subsampling to decrease computational requirements. Preferably, a resource checking algorithm is implemented as described in FIG. 19, to ensure that the system is not overloaded.

As shown in an exemplary method 1900, the method starts with an I/O (data read/write) transaction received by the file system in 1902. The program begins monitoring the data as requested in the I/O transaction in 1904. The program then checks for temporal inefficiencies in 1906, which relates to inefficiencies in storage that may cause delays in data retrieval.

In 1908, the program checks whether there are sufficient computational resources to conduct a reallocation. Preferably this is performed even before the process of reallocation begins, to avoid reducing system efficiency and/or causing damage to the system, due to an attempt to reallocate data with insufficient resources. If there are sufficient resources, the process continues in 1912 with, for example, the method of FIG. 3.

However, if it is determined that there are not sufficient system resources, then in 1910, the program determines if a non-disqualifying resource allocation situation exists that would still permit the process of reallocation to continue. For example, a non-disqualifying situation could include a temporary load on the system. Another such situation could include the determination that reallocation would improve system functioning overall, even if it caused a temporary excess load on the system. The balance between system stability and performance is also referred to in the detailed description of 13B. In addition to the details presented in that section FIG. 19 refers to temporary constraints on the system that a user may not predict. For example, a server may experience a temporary spike in traffic for some reason. The traffic spike may last for a short period of time thereby not warranting resources dedicated to optimization. In addition, the traffic spike may not be occurring on mission critical data. However, the program application cannot make such value judgements without input from a user. What the program can do is utilize the maps it has created, if the program knows that the data being access has recently been created or entered into the server it is highly likely that this is mission critical data and therefore, optimization should take place during this new peak load even though it would take resources away from supplying the demand for the data. The reason for this is that the peak load for new information would most likely last for such a time period that optimization would result in less time spent at peak load as the demand for data would be satisfied at a higher rate. In comparison, data that has resided on the theoretical server for a long period of time, especially data that is rarely access can be said to receive a peak load due to some externality. In this regard it is most likely the best course of action to simply let the peak load pass and conduct no optimization. The reason is that the demand will most likely peak and rapidly decline in a short period of time. Whereas new data will most likely still receive high access requests even after the peak. In situations involving old data or cold storage data, optimization preferably also continues at 1912 after further resources are provided to the system. Furthermore, user configurations may be added so that in the event of a peak load and an inefficiency a system administrator can make the value judgement to manually optimize the data operation. Additionally, settings may be put in place so that the program application understands the cases in which the system administrator would want an optimization to take place during times of peak loads, thus automated the process of the value judgement taking place.

The algorithms that require the most computational intensity are ones that are involved in the reallocation, or the labeling of the data in the storage space. On the other hand, the algorithms that are involved with the collection and referencing of a data map and any inefficiencies utilize significantly less computational power. Due to this, the system will first check if there are extra system resources available before beginning any reallocation. However, if there is currently a computationally intense task that is being performed, a system utilizing embodiments of the present invention will perform a calculation to evaluate the benefits of any reallocation. The system will process the historical utilization and present utilization. From there, the system will then account for the variation in the historical utilization and any deviation the current utilization has with historical utilization. This will allow the system to determine if there is any data that is utilized over time that does not have a high priority in the current environment but is utilizing an unproportionable amount of system resources. From there the system will determine whether there would be performance gains from diverting the system resources from unneeded functions to critical functions, or if it would be more efficient to let the system operate in its current state.

An example of the above mention error prevention method is in the video encoding space. Video encoding happens irregularly, requires a large amount of system resources, and requires different data for different projects. This makes optimizing the data transmissions extremely difficult in a predictive manner. The error prevention method within the invention gives a way to perform optimization even in random events.

Over time the system will have acquired trend knowledge of events that have occurred and will compare current events to those historical events. The system will also know the length any given event has occurred. In the case of video encoding the system will know what data is utilized stably over time, and how long previous editing events occurred. Based on this information the system can determine that if the editing events occur over a short period of time that any diversion of system resources will most likely result in an overall longer period of time due to the resource requirements of allocation versus encoding. On the other hand, over a long period of time, or in programs that do not take advantage of all system resources, there is an opportunity present to decrease the total amount of time spent encoding, even if there would be a momentary decrease in speed. The momentary decrease in speed would be due to the diversion of some system resources. However, once the allocation has been performed the speed would then be greater than the randomly allocated data speed.

A system utilizing this methodology would determine based on all the factors available to it what is the best optimization course possible. This is including the potential for no optimization taking place. Even systems that have the exact hardware specifications could have different optimization requirements given the same situation. This is because hardware specifications, and current computational tasks are only two variables out of the hundreds that are involved in optimizing a memory profile in any given situation. While the system can be made infinitely complicated this of course will require more computational power to figure out the optimal structure of data.

The previous methodologies utilizing file storage and physical storage blocks are also operable with object-based storage. However, preferably changes are made in order to utilize the present invention in an object-base storage system. Additional changes may be necessary for object-based storage that does not utilize a physical block storage methodology, but rather solely relies on meta-data tags to recreate a set of data. For object-based storage systems that do not utilize physical blocks, preferably the methods described herein are used at the data transfer stage rather than the physical rearrangement of data on a more permanent basis.

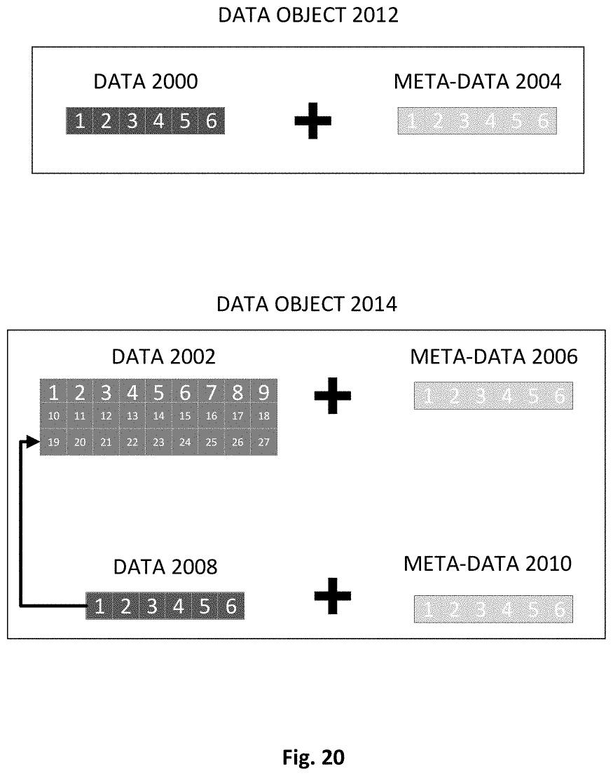

The reason for such a preference is due to the fact that object storage is internally consistent. The internal consistency refers to the fact that all data within an object is consistent with itself, unlike in block storage which is randomly allocated. FIG. 20 illustrates two examples of objects in an object storage system. Object 2012 is internally consistent in the data 2000 section whereas in a block there could be extra data written in due to the requirement to have standardized block sizes. However, in an object storage system data from object 2014 is not written into object 2012. Typically the objects have meta-data that delineate between different objects, preventing such a combination. Furthermore, because it is the metadata that ties the structure together, the data physically sits randomly inside a physical storage device. For this purpose object storage is generally used to store unstructured or static data that does not change often. However, while there is internal consistency there is an issue when object-based data is transferred as there are no blocks to indicate a termination. What this means in practice is that during transfer all the data from the selected regions will be sent. This leads to problems when it is data of differing access speed as again the entire transfer speed will be based on the fastest speed of the slowest piece of data, exactly the same issue that occurs during block storage transfer.

FIG. 18 helps illustrate how the methodology in the present invention is beneficial in the transfer of object data for content delivery networks. As illustrated by 1800 and 1810 the optimization preferably does not occur in the content or data itself, but preferably does occur during the transfer sequence, again due to the previously noted internal consistency of each of the objects inside the container. However, when the objects are being transferred elsewhere there is no order to which pieces of data are sent due to the fact that all pieces of data exist in a large blob connected only by meta-data tags on a physical storage device. This can lead to issues such as desynchronization, slower transfer speeds, and other issues depending on what type of data is being transferred. For example, unstructured data may only suffer from slow transfer speeds which over many terabytes of data can results in extremely long wait times to conduct data analysis and also removes real time data analysis. Another example is desynchronization for media object files such as audio and video. When the data stream is transferring at a lower rate than the encoded bitrate for a video file there will be desynchronization issues for content delivery.

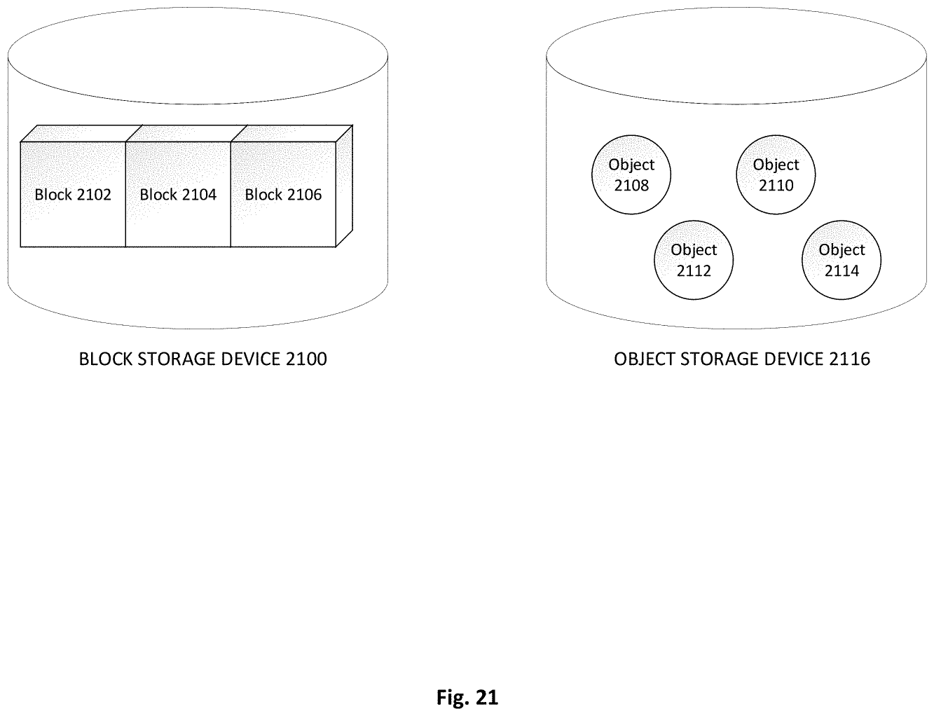

Any method as described herein may be used for object-based storage. FIG. 21 illustrates why the examples present in this description focus on optimizing data transfers of object-based storage rather than optimizing the storage itself. As indicated in the Object Storage Device 2116, objects 2108-2114 are randomly allocated throughout the storage device. In comparison in the Block Storage Device 2100, blocks 2102-2106 have a certain structure within the storage device. However, as indicated in FIG. 1 the blocks themselves have randomly allocated data. It is the reallocation of data based on the methodology described herein that produces the optimization and other non-limited benefits. In accordance with object-based storage reallocating data within the object storage itself has no effect as the object storage reads from any size of data no matter how large or small. It is when that data is accessed remotely or transferred that there are inefficiencies due to the random allocation of data across the entire storage device. In effect, the optimization would take place in a similar process as in FIG. 18 where media content represents a generic object and the reallocation and optimization occurs before the data is sent to a client. This allows the data transfer to proceed smoothly with less chance of critical errors to occur and for the maximum transfer speed to be used at any given moment. The above description simply makes reference to some of the capabilities of the methods described herein and in no way suggests that the invention is limited to these set of features.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The preceding description seeks to highlight certain features present within the invention described herein. Alterations or variations on the described methods can be made so that some or all of the advantages can be attained. Therefore, it is the aim of the following claims to include such alterations or variations that are within the true spirit and scope of this invention.

What is claimed is:

1. A method for sub-allocating data blocks within a storage according to data utilization, the method being operative for a computational device, the computational device comprising a processor, a memory, a file system, and a storage system, the file system comprising a plurality of files, the files being organized into data blocks stored on the storage system, the file system being accessed through an application programming interface (API), the method comprising steps being performed by the processor according to a plurality of instructions in the memory, the method comprising a plurality of steps being performed according to instructions stored in the memory and executed by the processor, the method comprising:
monitoring input/output operations of the storage system, including monitoring temporal and spatial data access, wherein said data access includes data being read from and written to the storage;
monitoring the file system through said API to analyze a connection between storage system input/output operations and file operations;
analyzing said data blocks to determine how those data blocks are correlated with file system files and metadata about said data blocks;
constructing a map of data blocks according to said metadata to correlate said data blocks with data composing said blocks;
relating said map of data blocks to file system locations;
conducting a performance test of the data composing said blocks to determine the input/output per second capabilities of the data;
conducting a performance test of the data blocks to determine if there are any inefficiencies relating to the overall length of time to conduct an operation on the entire block based on the amount of time required to conduct an operation on the data;
if an inefficiency is detected in the data block, determining whether reallocating the data of the data block would be successful;
determining whether sufficient system resources are available to successfully reallocate each data block requiring reallocation;
determining whether reallocation would increase the level of performance of the system;
if sufficient resources are available and if reallocation would increase said level of performance, rearranging the data into blocks of consistent input/output speeds based on the data block map.

2. The method of claim 1, further comprising rearranging the data blocks to increase a locality of reference by decreasing a size of a data block that is to be accessed.

3. The method of claim 2, further comprising conducting an evaluation to check if the increased level of performance is sufficient to overcome a temporary cost of said reallocation.

4. The method of claim 3 wherein said increasing the locality of reference comprises subdividing a larger data block into smaller blocks; and
tagging the smaller blocks with a unique identifier so that the file system reidentifies data that has been physically moved and so that the file system interprets the smaller blocks as being collectively part of a larger set based on the unique identifier.

5. The method of claim 4 further comprising detecting a number of requests for the same data in a specific time frame that is over a threshold;
determining if placing the data receiving said requests in a higher performance storage or memory that is higher in a memory hierarchy would increase efficiency of retrieval;
if so, determining if the higher performance storage has enough storage space for the data;
moving the data block to the higher performance storage if sufficient space is available.

6. The method of claim 5, detecting that the data block is no longer receiving an over the threshold amount of requests; and moving the data block from the higher performance storage.

7. The method of claim 5 further comprising, if the higher performance storage does not have enough storage space, creating a highly local reference to the data block;
and storing the highly local reference in the higher performance storage.

8. The method of claim 1 furthering comprising, packing data blocks with consistent types of data at a tail end of a data storage block;
monitoring temporal characteristics, spatial characteristics, and input/output patterns of data to determine what data blocks are of similar types of data;
determining if storage space is available at the tail end of the block;
If so, locating data that has similar temporal characteristics, spatial characteristics, and input/output patterns; and
packing the similar data into the tail end of the data block.

9. The method of claim 8 further comprising determining whether the data is being modified, and reserving space for modified data in the data block.

10. The method of claim 8 further comprising:
monitoring the data blocks for modification;
determining that the data is not modified repeatedly after an elapsed period of time; and
filling the data block to save storage space.

11. The method of claim 1 further comprising reconstructing data blocks with consistent types of data by monitoring temporal characteristics, spatial characteristics, and input/output patterns of data to determine what data blocks are of similar types of data; and
rearranging the data on the physical level into blocks that are of similar temporal characteristics, spatial characteristics, and input/output patterns, wherein said rearranging includes creating new blocks and tail packing data to reduce storage required for creating consistent data blocks.

12. The method of claim 11 wherein said rearranging includes leaving references at a previous location of the data block determining a new location of the block.

13. The method of claim 1 further comprising intelligently allocating data blocks into different memory hierarchies based on monitored system needs, by monitoring temporal activity, spatial activity, and input/output operations of data to determine the rate at which data is being accessed, and with what resources that data needs to be accessed;
determining what data is immediately necessary to be stored in the primary system memory;
Based on the number of requests over a given time period, and/or the change in those number of requests, optimizing the location of the data blocks based on the I/O speed of the primary system memory and the external system memory; and
relocating data to the external memory according to the number of requests and/or change thereof.

14. The method of claim 13 further comprising receiving a plurality of requests from a plurality of program applications, and determining a relative requirement for the rapidly accessed memory according to said requests.

15. The method of claim 14 further comprising receiving a plurality of requests from the operating system, and balancing said requests between said program applications and said operating system.

16. The method of claim 13 further comprising allocating data blocks into different memory hierarchies based on user specified parameters, by receiving instructions about a memory hierarchy;
receiving specifications for a preferred data storage allocation;
allocating data blocks according to said specifications and said instructions.

17. The method of claim 1, wherein said file operations comprise one or more of reading from a file, writing to a file, opening a file, closing a file, creating a file, copying a file, pasting a file and deleting a file.

18. The method of claim 1 further comprising constructing a virtual archetype of a unique detected file format based on detected metadata of the file stored in the storage according to said monitoring;
comparing accessing of the file to said virtual archetype;
according to the monitoring and the comparing to the virtual archetype, determining a correct file format for the file.

19. A computational device, comprising one or more processors, a plurality of instructions executable by said processor, a file system, a storage and an operating system, the operating system directing said processor to execute said plurality of instructions, the file system comprising a plurality of files, the files being organized into data blocks stored on the storage, the instructions including instructions for reading data from and writing data to said data blocks, and for organizing said data blocks, the one or more processors being operative to perform the following steps according to said instructions;
monitoring activity of the file system and of the storage, including monitoring temporal and spatial data access, wherein said data access includes data being read from and written to the storage; and
rearranging the data blocks that are being accessed to increase a locality of reference by decreasing a size or increasing a homogeneity of a data block that is to be accessed.

20. The device of claim 19, further comprising an application program, wherein said processor is operative to execute said plurality of instructions according to said application program.

21. The device of claim 19, further comprising firmware operative to control access to said storage, wherein said instructions are stored on said firmware, wherein at least one processor is associated with said firmware to execute said instructions.
A storage device controller, said storage device controller being operative to control storage in a computational device, said storage device controller comprising a processor, a plurality of instructions executable by said processor, and a file system, the file system comprising a plurality of files, the files being organized into data blocks stored on the storage, the instructions including instructions for reading data from and writing data to said data blocks, and for organizing said data blocks, the processor being operative to perform the following steps according to said instructions;
monitoring activity of the file system and of the storage, including monitoring temporal and spatial data access, wherein said data access includes data being read from and written to the storage; and
rearranging the data blocks that are being accessed to strengthen the locality of reference by decreasing the storage size or increasing a homogeneity of a data block that is to be accessed.
